(19) United States
(12) Patent Application Publication
(10) Pub. No.: US 2026/0028909 A1
(43) Pub. Date: Jan. 29, 2026

(54) FILTER SYSTEM FOR REMOVING DUST PARTICLES FROM UNDERGROUND MINING AND METHODS OF USE THEREOF

(71) Applicants: Sunghwan JUNG, Ithaca, NY (US); Lei PAN, Houghton, MI (US); Hassan AMINI, Morgantown, WV (US); VIRGINIA TECH INTELLECTUAL PROPERTIES, INC., Blacksburg, VA (US)

(72) Inventors: Sunghwan JUNG, Ithaca, NY (US); Lei PAN, Houghton, MI (US); Hassan AMINI, Morgantown, WV (US); Aaron NOBLE, Blacksburg, VA (US); Shima SHAHAB, Arlington, VA (US)

(21) Appl. No.: 18/996,278

(22) PCT Filed: Jul. 18, 2023
(86) PCT No.: PCT/US2023/070430

§ 371 Date: Jan. 17, 2025

Related U.S. Application Data
(60) Provisional application No. 63/368,680, filed on Jul. 18, 2022.
(60) Provisional application No. 63/527,207, filed on Jul. 17, 2023.

(51) Int. Cl. E21C 35/22; B01D 33/03

(52) U.S. Cl. CPC E21C 35/22; B01D 33/0346

(57) ABSTRACT

Various examples are provided related to dust particle removal in underground mining. In one example, a filter system for removing dust particles includes a mesh system comprising one or more meshes, a frame bed for holding the mesh system, and vibrational energy transfer from the continuous miner to the mesh system. In another example, a method for removing dust particles includes contacting the dust particles with the filter system mounted to the continuous miner, where the continuous miner produces vibrational energy sufficient to vibrate the mesh in the filter system.

### CROSS REFERENCE TO RELATED APPLICATIONS

This application claims priority to, and the benefit of, U.S. provisional application entitled “Filter System for Removing Dust Particles from Underground Mining and Methods of Use Thereof” having Ser. No. 63/368,680, filed Jul. 18, 2022, and U.S. provisional application having Ser. No. 63/527,207, filed Jul. 17, 2023, both of which are hereby incorporated by reference in their entireties.

### BACKGROUND

Over the last 20 years, the flooded bed dust scrubber has been an integral component of dust control strategies for underground continuous mining operations. These units have been shown to be effective and robust in mining environments; however, several technical challenges and knowledge gaps limit their performance and efficiency. Most significantly, the filter mesh can easily be clogged, which leads to reduced cleaning capacity and frequent maintenance. This issue is further amplified given the natural tradeoff between mesh fineness, dust capture efficiency, and sustained air flow rate.

### SUMMARY

Aspects of the present disclosure are related to dust particle removal in underground mining. In one aspect, among others, a filter system for removing dust particles from underground mining comprises a mesh system comprising one or more meshes secured by a frame; a frame bed for holding the mesh system, wherein the frame bed receives vibrational energy from a continuous miner; and a means for transferring vibrational energy from the continuous miner to the mesh system, wherein the means for transferring the vibrational energy are positioned between and in contact with the frame bed and the mesh system. The mesh system can comprise two or more meshes adjacent to and in contact with one another. Each mesh can be the same mesh. Each mesh can be a different mesh. Each mesh can be a 100-mesh to 325-mesh. In one or more aspects, the mesh can comprise woven steel. The mesh can comprise 1 to 30 layers of woven steel.

In various aspects, the mesh can have a thickness of from about 1 mm to about 10 mm. The mesh can comprise a plurality of wires, wherein the wires have a diameter of from about 0.05 mm to about 0.20 mm. The mesh can be heated at a temperature of from about 700° C. to about 800° C. from about 5 minutes to about 60 minutes. Each mesh can comprise a coating. The coating can be hydrophilic. The coating can be nonionic surfactant comprising alkylene oxide units. The coating can comprise an inorganic material comprising hydroxyl groups exposed on the surface. The coating can comprise an inorganic material comprising one or more metal oxides. The frame can comprise aluminum, wood, stainless steel, or plastic. The frame bed can comprise aluminum. The means for transferring vibrational energy can comprise one or more springs. The spring can have a spring constant that provides a natural frequency greater than the range of frequencies produced by the continuous miner. The spring can have a spring constant from about 5×10⁵ N/m to about 2×10⁷ N/m. The means for transferring vibrational energy can comprise an elastic material.

In another aspect, a method for removing dust particles from underground mining produced by a continuous miner comprises contacting the dust particles with the filter system in any one of the aspects described above, wherein the filter system is mounted to the continuous miner, and wherein the continuous miner produces vibrational energy sufficient to vibrate the mesh in the filter system. The filter system can be configured between the inlet and outlet of the scrubber system, which is attached to the body of the continuous miner. In one or more aspects, the continuous miner can produce vibrational energy having a frequency of less than 1,000 Hz, or from about 100 Hz to 1000 Hz. The dust particles can be contacted with water prior to contacting the filter system. The method can comprise removing the filter system from the continuous miner, cleaning the mesh of the filter system to remove all or substantially of the dust particles from the mesh, and re-installing the filter system on the continuous miner.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a graphical representation of an example of a mesh system, in accordance with various embodiments of the present disclosure.

FIGS. 2A and 2B illustrate an example of a scrubber including a mesh system, in accordance with various embodiments of the present disclosure.

FIG. 3 is an image of an assembled bench-scale scrubber unit attached to a fan and dust collection unit, in accordance with various embodiments of the present disclosure.

FIGS. 4A-4E include images showing an example of a tunnel structure, in accordance with various embodiments of the present disclosure.

FIGS. 5A-5D include images of a coal dust feeding system, in accordance with various embodiments of the present disclosure.

FIGS. 6A-6G include images of a filter system, in accordance with various embodiments of the present disclosure.

FIGS. 7A and 7B illustrate examples of test data for the filter system of the bench-scale scrubber unit, in accordance with various embodiments of the present disclosure.

FIG. 8 illustrates sampling locations, in accordance with various embodiments of the present disclosure.

FIGS. 9A and 9B illustrate test results for vibration free and vibration enhanced operation, in accordance with various embodiments of the present disclosure.

FIGS. 10A and 10B illustrate examples of pressure drop across mesh screen during testing, in accordance with various embodiments of the present disclosure.

FIGS. 11A-11D and 12A-12D illustrate examples of dust collection efficiency, airflow loss, pressure drop, and particle accumulation during operation of the filter system, in accordance with various embodiments of the present disclosure.

FIGS. 13A-13N illustrate construction of a full-scale filter system including a vibratory mesh assembly, in accordance with various embodiments of the present disclosure.

FIGS. 14A-14F illustrate a dust scrubber unit including the filter system with vibratory mesh assembly, in accordance with various embodiments of the present disclosure.

FIGS. 15A-15C and 16A-16C illustrate examples of dust collection efficiency, airflow loss, and pressure drop during operation of the dust scrubber unit with the filter system, in accordance with various embodiments of the present disclosure.

FIGS. 17A and 17C illustrate water drop analysis results, in accordance with various embodiments of the present disclosure.

### DETAILED DESCRIPTION

Disclosed herein are various examples related to dust particle removal in underground mining. A vibrating mesh screen has the capacity to capture more particles by creating a larger effective surface area. The vibration not only provides a larger effective area to increase dust capture, but it also provides a self-cleaning mechanism that sheds clogged particles and sustains high air flow rates. An innovative energy harvesting approach is presented where mesh vibrations are supplied by capturing and translating the natural vibrations of a continuous miner during operation. Reference will now be made in detail to the description of the embodiments as illustrated in the drawings, wherein like reference numbers indicate like parts throughout the several views.

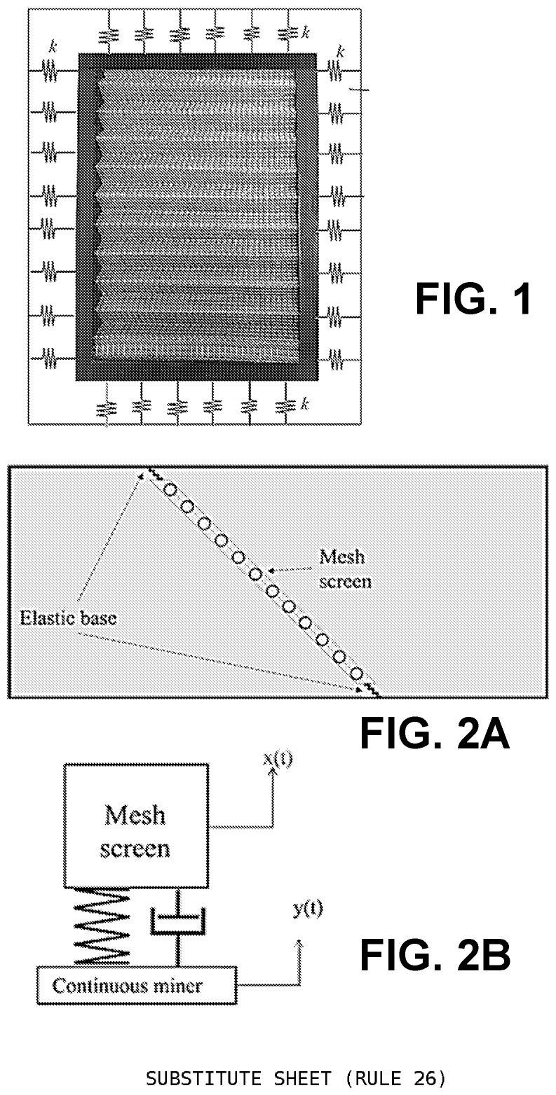

The feasibility of an energy harvesting technique is presented where the vibration of an operating continuous miner is utilized as the source of vibrational energy for the filter mesh. As depicted in FIG. 1, an elastic foundation of known spring constant can be used to transmit the system vibration to the mesh. The vibrational energy transmitted to the mesh screen can thus be controlled by proper selection of the spring constants of the elastic foundation. To evaluate this design, field data was first collected from an operating continuous miner, and through both modeling and experimentation a range of spring constants was identified that properly transmitted the optimal vibrational frequencies.

The efficiency of the vibrating mesh screen was assessed for vibrations ranging from 0 Hz to 1000 Hz in both X and Y directions. The simulation results indicated that the vibration in X-direction, even at a frequency of 50 Hz, results in a sharp increase in dust collection efficiency at the mesh screen. The dust collection efficiency increased as the vibration frequency increased. However, at frequencies over 600 Hz, the increase in dust collection efficiency was observed to be smaller.

Simulation results can serve as the basis to select the optimal range of frequencies that the mesh can be practically vibrated. The dust collection efficiency of the mesh scrubber system can be increased with the introduction of vibrations, which can be provided as harvesting energy from the operational vibrations of the continuous miner. An elastic base composed of springs can be used for the mesh to move in a particular direction. This base can utilize the shaking of the continuous miner as the source of vibrations and transmit that vibration energy to the mesh screen. The mesh screen vibrates independently of the continuous miner vibration frequency. The stiffness of the elastic base of the mesh scrubber determines the frequency of the output vibrations. FIGS. 2A and 2B illustrate a simplified mesh-spring-miner system. FIG. 2A is a schematic diagram showing the mesh screen and elastic base in the scrubber and FIG. 2B is an equivalent lumped-parameter damped mass-spring model of the scrubber, where x(t) is mesh screen displacement and y(t) is the miner displacement.

In the continuous miner, there are several different subsystems which altogether produce a spectrum of frequencies. These vibrations are experienced at the housing (base) of the mesh screen. The elastic foundation of the mesh screen is designed in such a way that the mesh resonates at a particular frequency from all the available frequencies imparted on the mesh base. This resonant frequency is the designed natural frequency of the elastic system. The energy transmitted to the mesh is highest when the driving frequency is equal to the system natural frequency. Consequently, if the natural frequency of the system falls within the spectrum of frequencies available to the mesh from the continuous miner, resonance occurs, and the mesh screen will vibrate at its natural frequency. At this frequency, the transmissibility of force from the source (continuous miner) to the mesh screen is the highest and the natural frequency of the system is amplified. The relationship of natural frequency, mass, and stiffness of the system is given as: fₙ=1/2π\sqrt{(k/m)}, where fₙ is the natural frequency (Hz), k and m are stiffness and mass of the system, respectively.

A system with a stiffness of k=8.7×10⁶ N/m has a natural frequency of 250 Hz. As a result, when excited the natural frequency is amplified, and the mesh vibrates primarily at 250 Hz. Similarly, a system with a stiffness of 3.48×10⁷ N/m has a natural frequency of 500 Hz, which is amplified due to the elastic base, allowing the mesh to vibrate at that frequency. This relationship between the stiffness of the elastic base and the natural frequency of the mesh scrubber system is given by k=4π²fₙ²m and can be utilized to design an elastic base that induces any desired dominant frequency on the mesh screen without the need for an external source. It can give the stiffness to design the elastic base for the mesh screen that vibrates at the desired frequency.

The peaks observed at the natural frequencies of the elastic base system confirm that the scrubber mesh predominantly vibrates at the system natural frequency, despite experiencing input vibrations of a wide range of frequencies. This result suggests that it is possible to design a system with a specific natural frequency that aligns with the range of frequencies encountered while the continuous miner is in operation. As a result, this system can induce vibrations in the mesh screen primarily at the desired frequency. Therefore, the presence of the elastic base can result in the mesh vibrating at the natural frequency of the system for all signals.

Technology evaluation was conducted through two test campaigns: (1) a bench-scale scale system; and (2) a full-scale prototype system. Each are described in separate sections below. Initially, the bench-scale system was evaluated to determine the optimal range of operating conditions (vibrational frequency, amplitude, water flow rates, etc.) through detailed parametric testing. Moreover, the smaller stature of the system allowed more detailed internal system analysis, particularly with the respect of particle deportment and fate through the system. Alternatively, the prototype system was tested at realistic operational conditions (air flow rate, dust concentration) in a high-fidelity simulated environment. While the same level of internal detail was not recorded during testing, the prototype testing was instead used to validate the smaller scale findings and stress test the system.

### Bench-Scale Testing

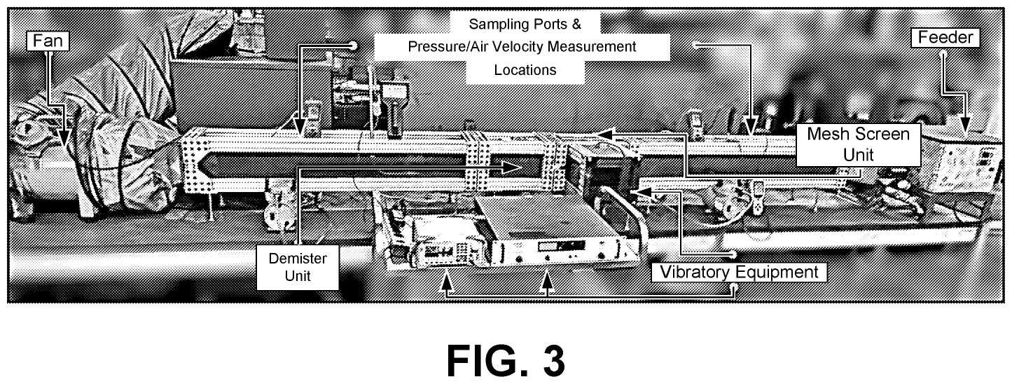

Design and Construction. A bench-scale scrubber was modified and refurbished in accordance with findings from initial proof-of-concept tests and initial system shakedown. These updates included the addition of: a new assembly for the mesh shaker and ancillary vibrational equipment, a new curve vane demister, and additional sampling ports. The chamber maintained the original 0.152 m×0.152 m internal cross-section, with the scrubber section comprising four detachable units and a shaker unit mounted on the mesh screen holder. The detachable units include: an upwind section where the coal dust can be fed into the system and from where the pre-mesh screen samples can be collected, a mesh screen unit, a demister unit, and a post-demister section where final downwind samples can be collected. FIG. 3 is an image showing the fully assembled unit attached to the fan and dust collection unit.

The mesh screen and demister housing sections are 0.36 m in length, and they have grated blackwater sumps underneath to collect wastewater for confirming the water flow rate measurements and supplying the outlet for wastewater from the mesh screen and demister units' floor. The longer sections provide the place for the sampling ports and allow the dust-laden air to travel from one unit to another and share a common length of 1.22 m. Altogether, the full system spans nearly 3.8 m in total length.

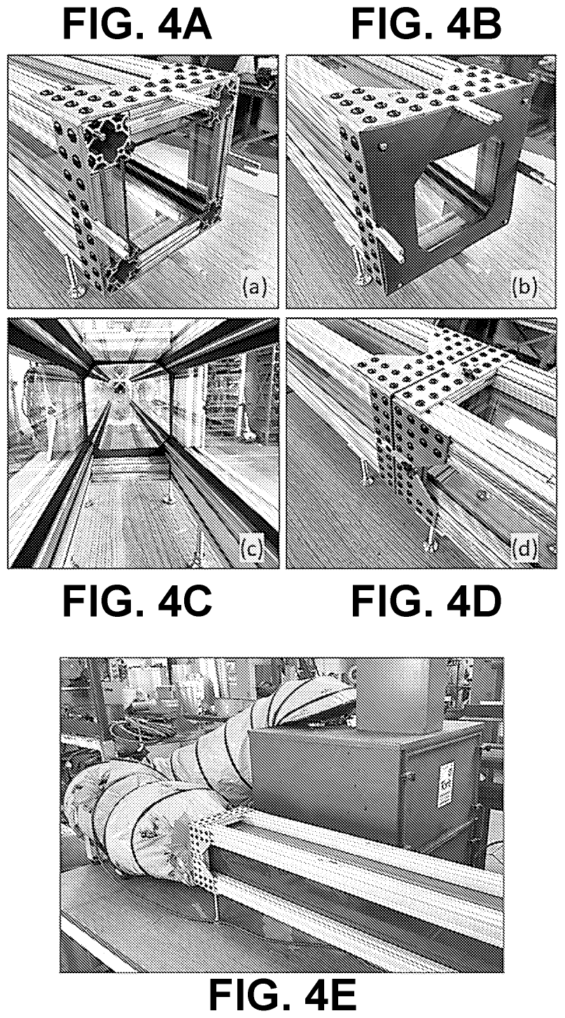

The framework of the scrubber comprises 80/20 extruded aluminum framing with walls made from clear polycarbonate. FIGS. 4A-4D include images showing the refurbished tunnel structure. The sections were made modular in nature and shared a new common mode of fastening. This fastening, shown in FIG. 4A, includes 6.35-mm inner alignment dowels and outer slide-locking alignment bars that are fastened with wing nuts for ease of assembly/disassembly during testing. In this modular configuration, sections can be separated and realigned quickly and in a manner that is both airtight and watertight. Another update included the addition of flat neoprene rubber seals between each section as shown in FIG. 4B and barbed neoprene rubber seals as shown in FIG. 4C running the length of each section around each joint containing the polycarbonate sheeting. This additional chamber sealing provided an airtight and watertight seal for verifying that no unmetered air entered or left the chamber during testing. The entirety of these changes is shown in FIG. 4D on one of the four main assembly joints. The system also includes a dust feeding system, an air-handling puller fan, an assortment of air sampling ports down the length of the tunnel, and an exciter that is mounted to the mesh screen.

Tunnel airflow is regulated by a nominal 2,700 cfm portable ventilation fan. The fan was selected to more accurately represent the airflow rates and velocities, in scale, of an industrial flooded bed scrubber. The fan was positioned at the end of the tertiary downward section of the chamber with its output fed into an industrial dust collection system as shown in FIG. 4E. The dust collection system ensures that no extraneous dust particles are entering the laboratory work area.

To properly size the exhaust fan for the laboratory-scale unit, the tunnel cross-sectional area was scaled down while maintaining a constant linear air velocity equal to that of a full-scale scrubber unit. The constant air velocity was selected as the scaling parameter, given that velocity dictates particle settling/suspension in the tunnel section. Data from NIOSH shows that typical measured volumetric flow rates in mine scrubbers are approximately 6,300 cfm. Moreover, geometric data shows that typical scrubbers have a cross-sectional area of 1.38×1.38 ft, though this value can vary significantly between models. Together, these values suggest that typical air velocities are on the order of 3,308 ft/min. Scaling this air velocity to the 6×6 in cross-section of the laboratory tunnel produced a target airflow rate of 827 cfm. After selecting and installing the fan, the actual airflow rate in the tunnel was measured using both a manual anemometer and a pitot tube. The results indicated that the airflow rate in the tunnel slightly exceeded the target velocity of 827 cfm.

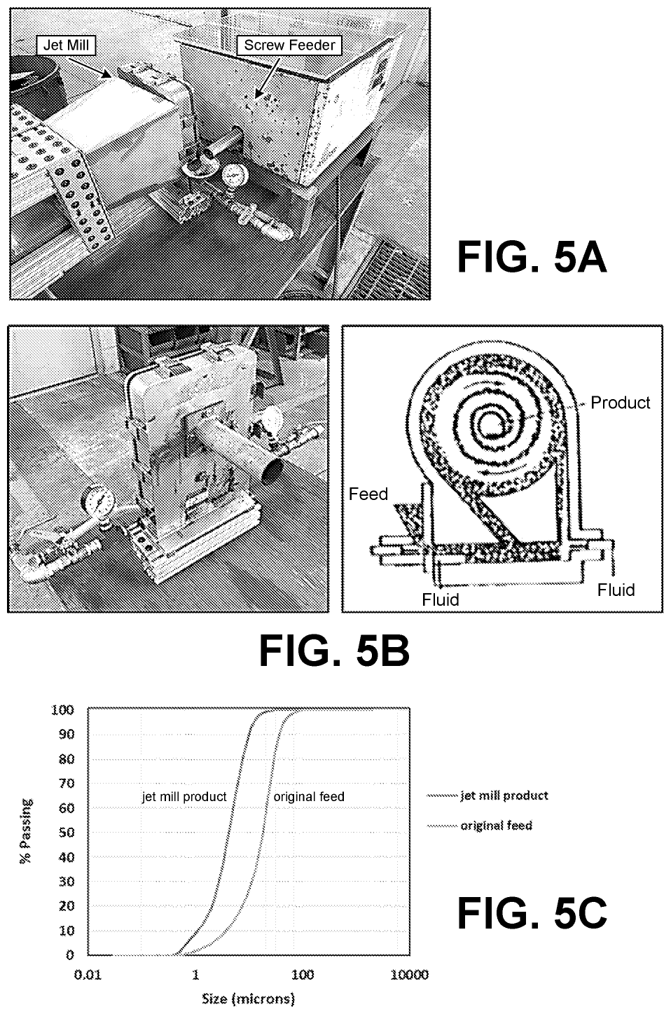

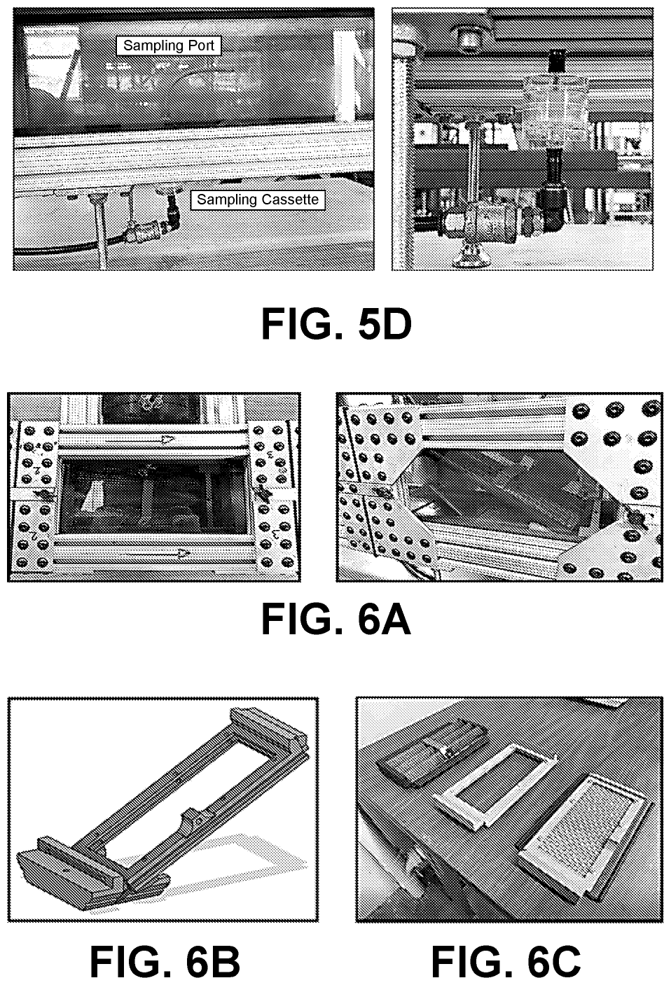

During testing, coal dust particles were injected into the scrubber by a feeding system comprising a volumetric screw feeder and a Trost jet mill, as shown in FIG. 5A. Characterization of the volumetric screw feeder was found to be linear in nature and thus extremely predictable, which in turn allowed dust concentration to be independently controlled as an independent variable.

To reduce the size of coal particles and create fresh dust surfaces, a laboratory-scale Trost jet mill was employed as shown in FIG. 5B. The jet mill employs high-velocity jets of compressed gas to impart energy to particles for size reduction. This device contains no moving parts in the grinding chamber, and the energy for size reduction is solely brought about by the carrier gas. The primary grinding action is by particle-particle attrition, and as such, no contamination is introduced during the grinding process. The compressed air, typically in a range from about 50 to 55-psi, sweeps the original feed particles around the grinding chamber. The particle interactions reduce the size of particles until the particles are fine enough to leave through the centrifugal classifier located in the grinding chamber.

The original feed and jet mill product were analyzed for particle size distribution using a Microtrac S3500 laser particle size analyzer. Data from this evaluation are shown in the particle size distribution plot of FIG. 5C. Based on the particle size analysis data, the top size of the original feed is approximately 300 microns, with approximately 59% coarser than 20 microns. A further parametric study of the jet mill also indicates it produces particles typically finer than 5 microns when operated at 55 psi jet pressure, and nearly 54% of the product is within the respirable range of below 5 microns. The ash and moisture content of the coal dust feed were determined by content analyses. In the analyzed sample, there is a low moisture content of 1.2% and a dry ash content of 16.2%.

During testing, dust samples are collected using 37-mm air sampling cassettes preloaded with Teflon filters. The first of the sampling locations, tasked with collecting pre-filtration data, was located within the preliminary upwind section, 0.2-m upstream from the secondary upwind section which contains the filter assembly. The second sampling port, tasked with collecting post-demister data, was located within the downwind section, 0.9-m upstream from the demister assembly. All sampling locations were placed in the long airflow sections to allow for more consistent air particulate mixing from the entrance and filter assembly sections of the scrubber.

The mesh screen, mesh screen unit blackwater sump and the demister unit blackwater sump were also sampled to further analyze the particle size distribution along the scrubber system and determine overall particle deportment/partitioning. The sampling ports themselves included identical long radius 90° bends of ⅛″ inner diameter copper tubing that were placed parallel to the incoming airstream at the centerline velocity of the chamber as shown in the images of FIG. 5D. Particulate matter capture testing was performed at all sampling locations with the chamber void of the filter and demister assembly to confirm that the sampling locations were collecting similar amounts of particulate at their respective locations. Air velocity sampling was also performed with the chamber fully dressed to confirm that similar mass flow rates of coal rich air was entering all cassettes to aid in accurately gauging capture efficiency.

To control the egress of water into the scrubber unit, a system of gate valves along with flowmeter was teed off of the laboratory building's water supply. Mass flow rate and pressure of the incoming water was set up and checked before testing using a timing system and container of specified fluid volume. As with the introduction of air into the system, the amount and pressure of water was also scaled down with a cross-sectional-area scaling factor calculated from the information obtained from an operational scrubber unit.

The nozzle is housed within the preliminary upwards section utilizing a bulkhead fitting and directed towards the middle section of the filter assembly. Due to its higher wettability efficiency, a brass 60° spray angle full cone nozzle which is capable of spraying at a rate of 0.25 gpm at 55 psi was employed in the test runs.

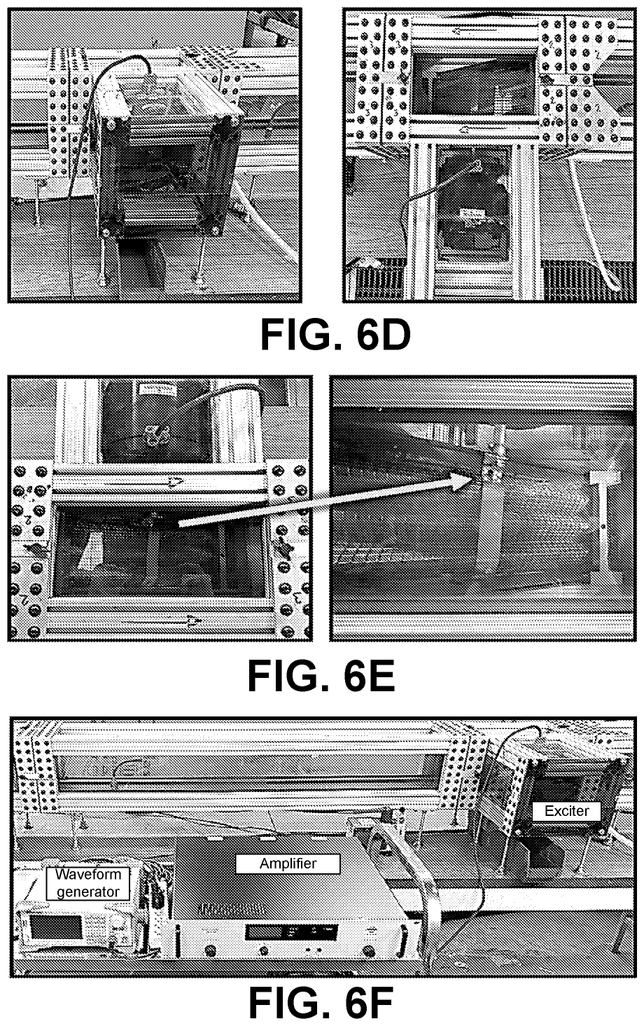

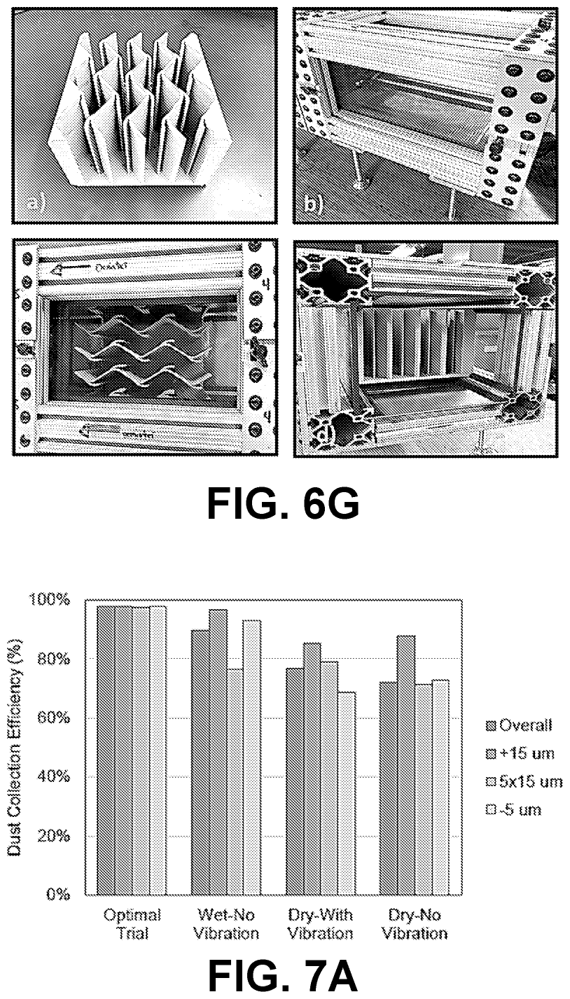

The filter mesh utilized in the scrubber unit was a small portion of an industrial-grade, steel-woven, scrubber mesh. The panel is approximately 6-mm in thickness and contains 20 layers of wire screen. The wire that the screen is composed of is 0.09-mm in diameter and is evenly spaced at 7 wires per centimeter of the screen. The panel is installed in the filter section of the scrubber at a downward sloping angle of 45° with a face area totaling 0.074 m². FIG. 6A includes images of top and longitudinal views of the filter assembly. The mesh screen housing includes two additively manufactured parts to hold the screen steady while it shakes including a quick-change stainless-steel mount for the upper part of the screen and a lower mesh mount. FIG. 6B schematically illustrates an example of a mesh frame adapter assembly and FIG. 6C is an image of additively manufactured frames. The additive parts were also optimized for water collection and mesh sealing. As installed, the filter assembly can be easily interchanged to integrate design modifications (e.g. hydrophobic/hydrophilic treatment, modifications to mesh layering) as dictated by the experimental design.

An extra unit containing the shaker was designed and mounted to the system in such a way that it can be attached to the mesh screen unit from the side. FIG. 6D includes images of top and longitudinal views of the shaker assembly. This unit completely protects the shaker from water and coal dust exposure and allows the mesh screen to be connected to the aluminum rod end of the shaker.

The mesh screen itself was connected to an electromechanical shaker (Bruel and Kjmr Type 4809) by an actuating rod and clamping mechanism. FIG. 6E includes images showing the clamping mechanism between the shaker's actuator rod and mesh screen. The square waves were generated by a SDG1000X function waveform generator and applied to the shaker through a Bruel and Kjmr Type 2718 power amplifier for base excitation over a range of frequencies. The vibration equipment, as shown in the image of FIG. 6F, are located around the mesh screen section in the test set up.

A demisting assembly was added to the system to create a more accurate representation of a full-size scrubber assembly. An in-house and purpose-built demister assembly (curved vane demister) was designed, 3-D printed, and additively manufactured. The images of FIG. 6G illustrate the demister assembly. Image (a) shows the additively manufactured curved vane demister, image (b) shows the bottom of the demister (water collection equipment), and images (c) and (d) show top and front views of the shaker assembly. This unit was then tested and shown to increase airflow and water collection into the bottom sump that actively pulls excess water from clean charge air while maintaining sufficient flow rates through the chamber.

Materials and Methods. During each trial, several parameters were kept constant to minimize random error and ensure that the experiments were conducted in a steady, stable manner. The fixed test parameters are listed in table 1.

TABLE 1
Fixed operating parameters.

| Property | Value | |
|---|---|---|
| Dust feed rate | 14.0 to 22.7 | g/min |
| Downwind airflow velocity | 10 | m/s |
| Sampling method | Gravimetric Sampling | |
| Sampling duration | 5 | min |
| Sampling pump flow rate | 5 | lpm |
| Jet mill pressure | 55 | psi |
| Signal generator gain | 20 | Vpp |

Given the system factors, gravimetric measurement is considered to be the most reliable and least likely to lead to bias. For reliable quantification of gravimetric filters, and for reducing the impact of weighing error, a minimum mass accumulation in the downwind cassette of 1 mg was used. As such, the following was used to calculate the time needed for accumulating enough mass in the downwind sampling cassette for analysis:

$$t = m / [ Qpump * Cfeed * ( 1 - η ) ]$$

where m is the mass accumulation in downwind sampling cassette, Qpump is the sampling pump flow rate, Cfeed is dust feeding concentration, and η is the scrubber efficiency.

Before each trial, various portions of the system, including the mesh screen, demister, sampling ports, and black water sumps, were thoroughly cleaned with compressed air to ensure experimental integrity, and maintain a consistent airflow rate. In order to determine the dust mass differential collected in the specified time interval, sampling cassettes with the appropriate filters were weighed before and after each test. All experiments were conducted with the same cleaning procedure in order to compare the efficiency of all operational modes effectively.

Gravimetric samples collected during these tests were used to determine the dust collection efficiency:

$$Collection Efficiency ( \% ) = ( 1 - \frac{weight of downwind sample}{w eight of upwind sample} ) * 100$$

Using these general procedures, four test campaigns were conducted: (1) Vibrational Parameter Optimization; (2) Size-by-Size Performance Results; (3) Evaluation of Mesh Density; and (4) Evaluation of Mesh Surface Treatment. Additional protocols and distinctives for each campaign are discussed with the results below.

Vibrational Parameter Optimization Results. To investigate and evaluate the operational sensitivity of the bench-scale flooded bed dust scrubber, a three-factor, three-level Box-Behnken Design (BBD) was employed and the experimental data were statistically analyzed. Experimental factors for this study are given in table 2. Following this analysis, 3-D plots were developed to show the relationship between operating factors and collection efficiency as well as pressure drop and particle accumulation in the mesh.

TABLE 2
Experimental factors and range values
for vibrational parameter tests.

Level

| Factors | Low (−1) | Medium (0) | High (+1) |
|---|---|---|---|
| Water flow rate (lpm) | 6 | 7.5 | 9 |
| Amplitude (dB) | 20 | 30 | 40 |
| Frequency (Hz) | 130 | 2565 | 5000 |

In addition to the experimental variables, repeated trials at the center point demonstrate the importance of controlling constant operational parameters in the propagated pure error in the experimental program. Although all three repetitive runs were performed under the same levels of water flow rate, amplitude, and vibration frequency, it is thought that improper control of airflow rate in each trial resulted in different collection efficiency values.

The software used to create the BBD program provides the experimental design as well as statistical tools obtained from the test results and their relationships with the operational parameters to construct the statistical model with the lowest error as well as the highest reliability. Among these statistical tools, lack of fit, the coefficient of determination (R²), and the adjusted coefficient of determination (R²_{adj}) were particularly examined and considered adequate as they are some of the most critical statistics showing the reliability of the statistical analysis. Based on these analyses, optimal conditions were determined to maximize the bench-scale flooded bed dust scrubber dust collection efficiency.

The statistical analysis results of the experimental program based on a limited number of experimental studies do not necessarily indicate that the models have superior predictive capacity; however, the analysis results provide a rigorous tool to gain insight into the combinatory effects of operational parameters. The information obtained from this analysis can be used to guide modeling studies.

The experimental test results shown in table 3 describe the scrubber collection efficiency as a function of three operational parameters: the water flow rate, the vibration frequency generated by the waveform generator, and the amplitude of that signal. The results of the experimental setup created with 12 different combinations of these 3 parameters emphasize the importance of the mentioned operational factors in determining the collection performance of the mesh screen. It can be seen from the surface plots slight changes in the level of the variable may significantly affect the collection efficiency. For instance, while the efficiency was 96.22% in the 11^{th} run, after the level of the variables changed slightly, the efficiency of the system decreased to nearly 18% in the 3^{rd} run.

TABLE 3
Summarized collection efficiency results
for bench scale scrubber optimization.

| | Variables | | | |
|---|---|---|---|---|
| | Water Flow | | | Collection |
| | Rate | Amplitude | Frequency | Efficiency |
| Experiment | (lpm) | (dB) | (Hz) | (%) |
| 1 | 7.5 | 40 | 130 | 97.25% |
| 2 | 7.5 | 20 | 130 | 95.27% |
| 3 | 6 | 30 | 130 | 68.45% |
| 4 | 9 | 30 | 130 | 97.15% |
| 5 | 6 | 20 | 2565 | 84.71% |
| 6 | 9 | 20 | 2565 | 93.31% |
| 7 | 6 | 40 | 2565 | 84.36% |
| 8 | 9 | 40 | 2565 | 94.21% |
| 9 | 9 | 30 | 5000 | 89.97% |
| 10 | 6 | 30 | 5000 | 30.38% |
| 11 | 7.5 | 40 | 5000 | 96.22% |
| 13 | 7.5 | 20 | 5000 | 93.39% |
| C1 | 7.5 | 30 | 2565 | 90.48% |
| C2 | 7.5 | 30 | 2565 | 93.93% |
| C3 | 7.5 | 30 | 2565 | 80.42% |

As shown in the collection efficiency results in table 3, the collection efficiency usually increases as the water flow rate increases. Also, it can be inferred from surface plots of the collection efficiency results that the collection efficiency generally increases with the increase in amplitude, therefore, this value is also in a linear relationship with the performance of the mesh screen collection ability. However, this relationship is not as steep as it is in the water flow rate-collection efficiency relationship, as it can be deduced from fitted line plots. Unlike the mentioned two variables, no linear relationship and proportionality between frequency and collection efficiency have been determined. For example, an increase in the frequency may result in either improving or reducing the flooded bed dust scrubber performance efficiency based on the level of water flow rate and amplitude.

The results of these tests were also subjected to particle size analysis. As shown in table 3, the results obtained from the particle size analysis are mostly in agreement with the overall collection efficiency values in the range of 5 μm to 15 μm and larger particle sizes. The inconsistency below 5 μm may be attributed to the ultrafine particles being more likely to adhere to the filter and not easily separated when scraping the filter.

As explained above, the collection efficiency usually increases with an increase in the water flow rate and amplitude. However, no linear relationship between frequency and collection efficiency was observed. Nevertheless, the performance of the mesh screen's collection efficiency increases much more when a vibration frequency of around 130 Hz was applied. Therefore, low frequency, high water flow rate, and high amplitude will be the most optimal application for increasing the collection efficiency.

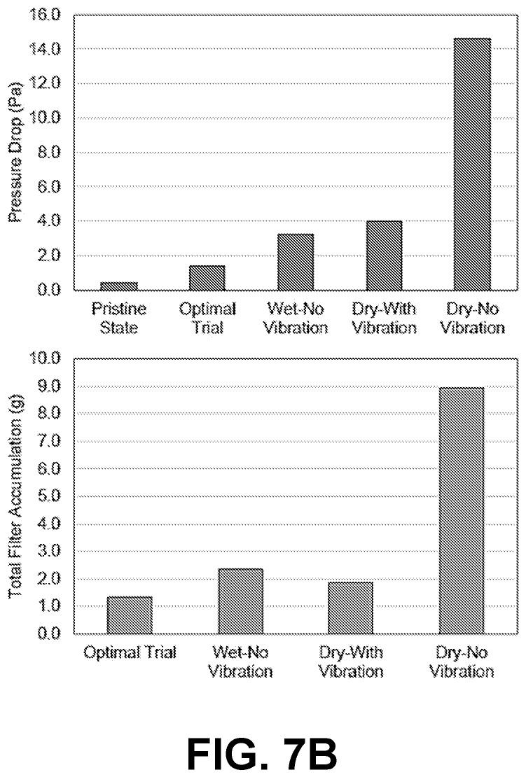

The optimum collection efficiency was identified through interpolation using the RSM plots and regression model generated from the experimental program (water flow rate (+1 or 9 L/min); amplitude (+1 or 40 dB); and vibration frequency (−1 or 130 Hz)). This result was compared to that of the other scrubber operational modes, including dry testing and no-vibration testing. Data from this comparison are shown as a function of size class and overall in table 4 and FIG. 7A. The vibration imparts considerable improvement in overall collection efficiency in both wet (98% versus 90%) and dry (77% versus 72%) conditions. The results were most pronounced in the intermediate size class (5×15 microns); however, improvements were also observed in the finest size class in the wet condition.

TABLE 4
Summarized collection efficiency data for various scrubber operational modes.

| | Variables | | | Collection Efficiency (%) | | | |
|---|---|---|---|---|---|---|---|
| | Water Flow | Amp. | Freq. | | 5 × 15 | +15 | |
| Experiment | Rate (lpm) | (dB) | (Hz) | −5 μm | μm | μm | Overall |
| Optimal Trial* | 9 | 40 | 130 | 97.68 | 97.36 | 97.62 | 97.86 |
| Wet-No Vibration | 9 | 0 | 0 | 93.02 | 76.54 | 96.57 | 89.68 |
| Dry-With Vibration | 0 | 30 | 130 | 68.77 | 78.87 | 85.17 | 76.62 |
| Dry-No Vibration | 0 | 0 | 0 | 72.84 | 71.15 | 87.96 | 72.15 |

*Optimum results were predicted using the RSM plots and regression equation obtained from the BBD test results

Finally, the upwind and downwind tunnel section were both subjected to pressure drop measurement to determine and quantify the self-cleaning potential of the vibrating mesh system. In addition, after testing, the mass accumulation of dust in the filter was measured and recorded. Data from these trials are shown in table 5 and FIG. 7B for the various operational conditions as well at the optimal trial determined from BBD. As shown, the vibration imparts a significant improvement to clogging mitigation in both the wet and dry conditions. For the wet mesh trials, a 56% reduction in pressure drop and a 43% reduction in filter accumulation were achieved as a result of the induced vibration. Even greater reductions were observed in the dry mesh trials, providing further support that induced vibration offers a cleaning mechanism that will prolong the mesh filter operational time.

TABLE 5
Summarized clogging data for various scrubber operational modes.

| | | | | | Total |
|---|---|---|---|---|---|
| | Variables | | | | Filter |
| | Water Flow | | | Pressure | Accumu- |
| | Rate | Amp. | Freq. | Drop | lation |
| Experiment | (lpm) | (dB) | (Hz) | (Pa) | (g) |
| Pristine State | N/A | N/A | N/A | 0.45 | N/A |
| Optimal Trial | 9 | 40 | 130 | 1.42 | 1.35 |
| Wet-No Vibration | 9 | 0 | 0 | 3.24 | 2.36 |
| Dry-With Vibration | 0 | 40 | 130 | 3.99 | 1.86 |
| Dry-No Vibration | 0 | 0 | 0 | 14.62 | 8.96 |

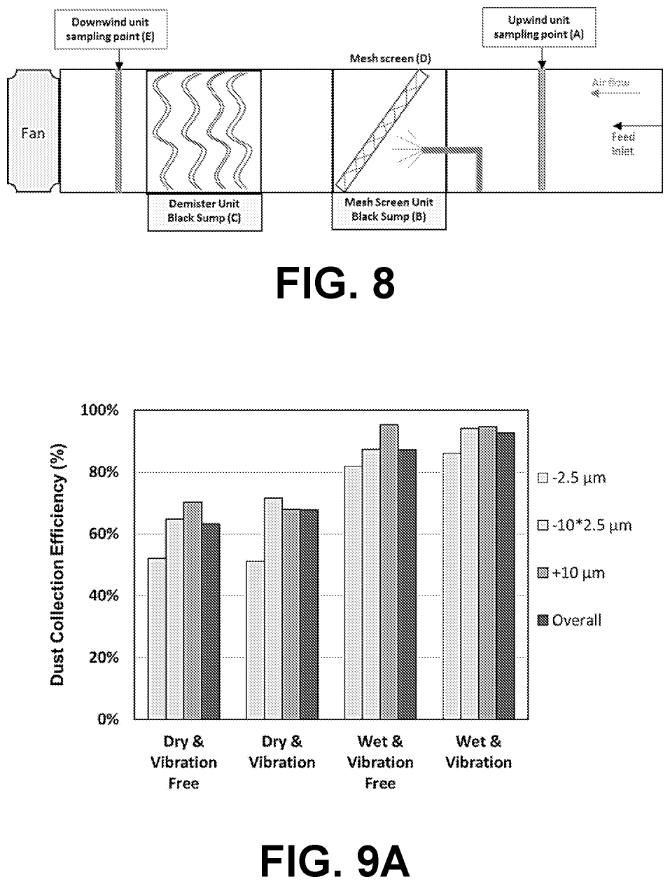

Size-by-Size Performance Results. Using the optimized parameter values identified in the previous section, a series of follow-on trials were conducted to investigate the size-by-size deportment of particles through the system. In this study, representative samples were taken at predetermined locations across the system. The coded sampling locations along the chamber are illustrated in FIG. 8. After collecting samples from these locations, the coal dust particles from the Teflon filters as well as coal dust & water mixture from the mesh screen itself, mesh screen section blackwater sump and demister section blackwater sump were analyzed with Microtrac laser particle size analyzer to determine the particle size distribution of each sample.

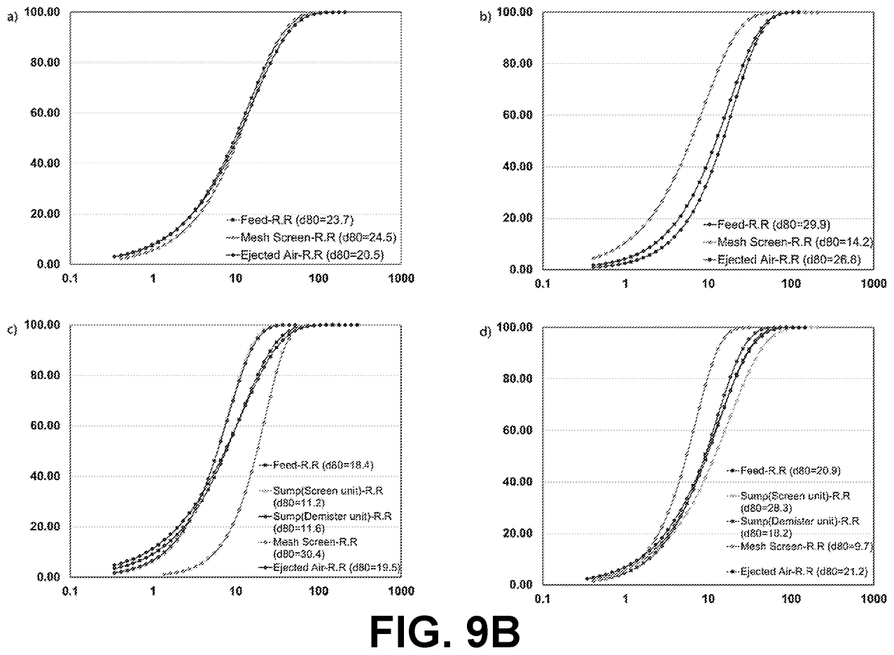

Table 6 to table 9 and FIGS. 9A and 9B show the size-by-size results of this study for both vibration free and vibration enhanced operation in both dry and wet modes. The particle amounts sampled at the predetermined locations were listed in the results as both a percentage of stream (i.e. the size distribution of the sample stream) and a percentage of feed (i.e. mass recovery to the stream).

In the dry operational conditions (tables 6 and 7), over half of the feed mass accumulated on the floor of the duct between the mesh screen and demister and was thus not found in the various sampling endpoints. While this result does hinder the interpretation of the material balance, the data does provide evidence that intermediate sized particles (10×2.5 microns) are being preferentially recovered in the mesh screen, as indicated by the higher % of feed recovery for this size class as compared to the other classes. In addition, the dry data indicates that the vibration leads to lower accumulation in the mesh screen, as the total % of feed recovered to this stream was reduced from 7.59% to 4.51% with the addition of vibration.

TABLE 6
Summarized size-by-size material balance data for wet and vibration-free operational mode.

| | | | Sump | | Sump | | | | | | |
|---|---|---|---|---|---|---|---|---|---|---|---|
| | | | (Screen | | (Demister | | Mesh | | Ejected | | U/S − D/S |
| | Feed (A) | | Unit) (B) | | Unit) (C) | | Screen (D) | | Air (E) | | Collection |
| Size | % of | Mass | % of | % of | % of | % of | % of | % of | % of | % of | Efficiency |
| (μm) | stream | (g) | stream | feed | stream | feed | stream | feed | stream | feed | (%) |
| +10 | 35.04 | 39.77 | NA | NA | NA | NA | 28.28 | 6.12 | 28.27 | 29.7 | 70.29 |
| 10 × 2.5 | 37.23 | 42.26 | NA | NA | NA | NA | 54.78 | 11.1 | 35.59 | 35.2 | 64.80 |
| −2.5 | 27.73 | 31.47 | NA | NA | NA | NA | 16.94 | 4.64 | 36.14 | 47.9 | 52.01 |
| Total | 100.00 | 113.5 | NA | NA | NA | NA | 100.00 | 7.59 | 100.00 | 36.8 | 63.18 |

TABLE 7
Summarized size-by-size material balance data for dry and vibration operational mode.

| | | | Sump | | Sump | | | | | | |
|---|---|---|---|---|---|---|---|---|---|---|---|
| | | | (Screen | | (Demister | | Mesh | | Ejected | | U/S − D/S |
| | Feed (A) | | Unit) (B) | | Unit) (C) | | Screen (D) | | Air (E) | | Collection |
| Size | % of | Mass | % of | % of | % of | % of | % of | % of | % of | % of | Efficiency |
| (μm) | stream | (g) | stream | feed | stream | feed | stream | feed | stream | feed | (%) |
| +10 | 46.08 | 52.30 | NA | NA | NA | NA | 33.98 | 1.53 | 45.89 | 14.8 | 67.83 |
| 10 × 2.5 | 43.51 | 49.38 | NA | NA | NA | NA | 47.92 | 2.16 | 38.33 | 12.3 | 71.54 |
| −2.5 | 10.41 | 11.82 | NA | NA | NA | NA | 18.10 | 0.82 | 15.78 | 5.10 | 51.03 |
| Total | 100.00 | 113.5 | NA | NA | NA | NA | 100.00 | 4.51 | 100.00 | 32.3 | 67.70 |

Data from the wet testing (tables 8 and 9) provide better accounting of the mass and as such provide better insight on particle deportment. As expected, the majority of the feed mass ultimately reports to the demister sump (53% for vibration free; 59% for vibration enhanced) however, a notable portion is also retained in the screen sump (23% for vibration free; 25% for vibration enhanced). Moreover, the data shows that the vibration enhanced unit has a higher collection efficiency (92.6% versus 87.2%) and lower accumulation in the mesh screen (2.9% versus 3.2%) when compared to the static mesh. As in the dry tests, the intermediate particles (10×2.5 microns) were preferentially recovered to the mesh screen; however, this trend was not as prominent as that found during the dry testing.

TABLE 8
Summarized size-by-size material balance data for wet and vibration-free operational mode.

| | | | Sump | | Sump | | | | | | |
|---|---|---|---|---|---|---|---|---|---|---|---|
| | | | (Screen | | (Demister | | Mesh | | Ejected | | U/S − D/S |
| | Feed (A) | | Unit) (B) | | Unit) (C) | | Screen (D) | | Air (E) | | Collection |
| Size | % of | Mass | % of | % of | % of | % of | % of | % of | % of | % of | Efficiency |
| (μm) | stream | (g) | stream | feed | stream | feed | stream | feed | stream | feed | (%) |
| +10 | 17.59 | 19.96 | 16.77 | 3.78 | 15.51 | 8.27 | 40.75 | 1.29 | 6.45 | 0.83 | 95.30 |
| 10 × 2.5 | 54.79 | 62.19 | 56.81 | 12.8 | 56.75 | 30.2 | 57.14 | 1.81 | 54.55 | 7.00 | 87.23 |
| −2.5 | 27.62 | 31.35 | 26.42 | 5.95 | 27.74 | 14.7 | 2.11 | 0.07 | 39.00 | 5.00 | 81.88 |
| Total | 100.00 | 113.5 | 100.00 | 22.5 | 100.00 | 53.3 | 100.00 | 3.17 | 100.00 | 12.8 | 87.17 |

TABLE 9
Summarized size-by-size material balance data for wet and vibration operational mode.

| | | | Sump | | Sump | | | | | | |
|---|---|---|---|---|---|---|---|---|---|---|---|
| | | | (Screen | | (Demister | | Mesh | | Ejected | | U/S − D/S |
| | Feed (A) | | Unit) (B) | | Unit) (C) | | Screen (D) | | Air (E) | | Collection |
| Size | % of | Mass | % of | % of | % of | % of | % of | % of | % of | % of | Efficiency |
| (μm) | stream | (g) | stream | feed | stream | feed | stream | feed | stream | feed | (%) |
| +10 | 30.33 | 34.42 | 36.60 | 9.12 | 29.81 | 17.5 | 14.12 | 0.40 | 21.67 | 1.61 | 94.73 |
| 10 × 2.5 | 48.94 | 55.55 | 45.09 | 11.2 | 52.71 | 31.0 | 60.05 | 1.72 | 39.02 | 2.87 | 94.11 |
| −2.5 | 20.73 | 23.53 | 18.31 | 4.56 | 17.48 | 10.3 | 25.83 | 0.74 | 39.31 | 2.90 | 86.00 |
| Total | 100.00 | 113.5 | 100.00 | 24.9 | 100.00 | 58.9 | 100.00 | 2.86 | 100.00 | 7.38 | 92.62 |

As shown in FIG. 9A, vibration improves overall collection efficiency in both wet (93% versus 87%) and dry (68% versus 63%) conditions. Similarly, the data shows that the presence of vibration generally has a positive effect on the collection efficiency of the system in finer size classes. While almost the same results were obtained in dry conditions for particles below 2.5 micron (52% versus 51%), a significant improvement in collection efficiency was observed in this size class under wet conditions (86% versus 82%). In the coarse size class, very slight decreases in collection efficiency were observed. While these decreases were more pronounced in dry conditions (70% under vibration versus 68% with no vibration), the difference was less significant in wet conditions (95% in both conditions).

To further assess the data, FIG. 9B shows the Gaudin-Schumann size distribution curves of the various product streams for the evaluated operational conditions. Plot (a) shows size distributions for the dry & vibration free mode, plot (b) shows size distributions for the dry and vibration mode, plot (c) shows size distributions for the wet and vibration free mode, and plot (d) shows size distributions for the wet and vibration mode. By comparing curves for the different conditions, the variations in particle size characteristics can be assessed and the distribution profiles can be understood better. When the operational conditions change from dry and vibration-free condition to wet and vibration condition, the sharpness of the curves are usually increasing. This is most prominent in the mesh screen section. It has a slope of 1.03 for the dry & vibration-free condition while it has a slope of 1.46 for the wet and vibration condition. This means in the wet vibration condition the mesh screen has a narrower particle size distribution.

The d₈₀ values obtained from the curves also show the significant change in mean particle size between the dry and vibration free conditions (d₈₀=24.5 microns) versus that of the wet with vibration condition (d₈₀=9.7 microns) (FIG. 9B). The decrease in this value shows that adding water to the system and vibrating the mesh screen at the same time will increase the possibility of finer dust particles getting captured by water droplets due to the increased surface wettability and improve the efficiency of the screening activity. It is also important to note that more of dust particles that were introduced to the stream were eliminated in the upwind section of the mesh screen. The blackwater sump located in the upwind section of the mesh screen largely collects the particles that are shed from the mesh screen surface. While the percentage of feed in the mesh screen section black water sump under the wet & vibration-free condition is 23%, the same parameter for the wet & vibration condition increased to 25%.

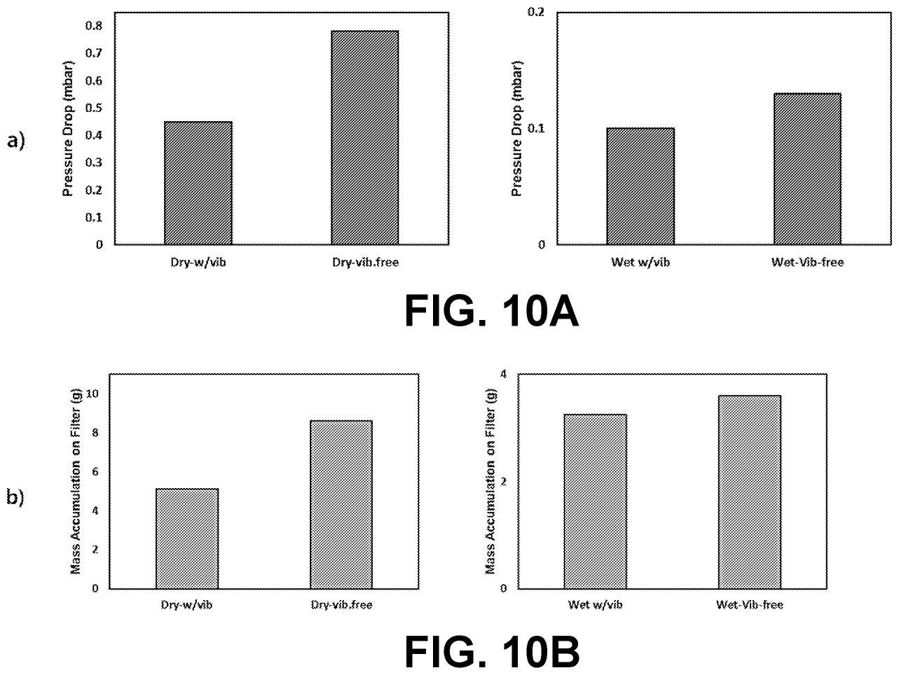

Mass accumulation on the mesh screen and pressure drop across the mesh screen are two indicators of the mesh screen's self-cleaning ability when vibration is applied. These data are given and illustrated in table 10 and FIGS. 10A and 10B. FIG. 10A shows pressure drop data across mesh screen in dry and wet operational conditions and FIG. 10B shows total accumulation between wire meshes in dry and wet operational conditions. When vibration was induced, the pressure drop across the mesh screen decreased by 23% and filter accumulation decreased by 9.7% in the wet environment compared to vibration-free test. In the dry condition, when the vibration was applied, a 43% decrease in pressure drop and a 41% decrease in mass accumulation were observed. The reductions supporting the proposed vibration enhanced mesh screen design can provide the mesh screen with a self-cleaning mechanism and enable the mesh screen to operate longer.

TABLE 10
Summarized clogging data for various scrubber operational modes.

| | Increase in | Total Mass |
|---|---|---|
| | Pressure | Retained |
| Operational | Drop | on Filter |
| Mode | (mbar) | (g) |
| Dry & Vibration-Free | 0.78 | 8.61 |
| Dry & Vibration | 0.45 | 5.11 |
| Wet & Vibration-Free | 0.13 | 3.6 |
| Wet & Vibration | 0.1 | 3.25 |

Influence of Mesh Density Results. Additional tests were conducted to evaluate the combined influence of mesh density and induced vibration on system efficiency. In this trial, three separate mesh densities, namely 30 layers, 20 layers, and 10 layers of woven stainless steel, were evaluated in both vibration enhanced and vibration free settings. All layering tests were conducted for 5 minutes of run time, and pressure drop was measured continuously throughout the test. Dust-laden air samples were collected upwind and downwind of the filter assembly to determine the dust collection efficiency. All tests were performed at an initial airspeed of approximately 9.5 m/s, and post-run air velocity measurements were taken to determine loss in air flow.

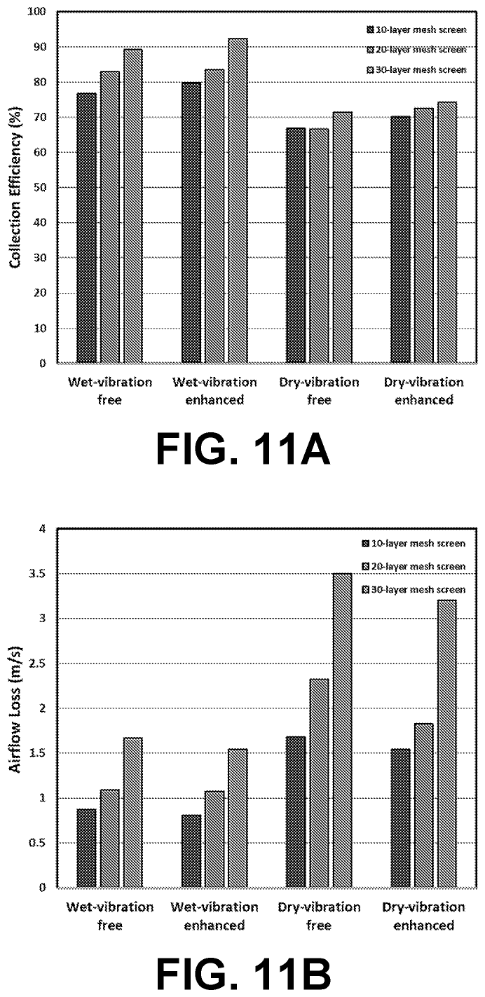

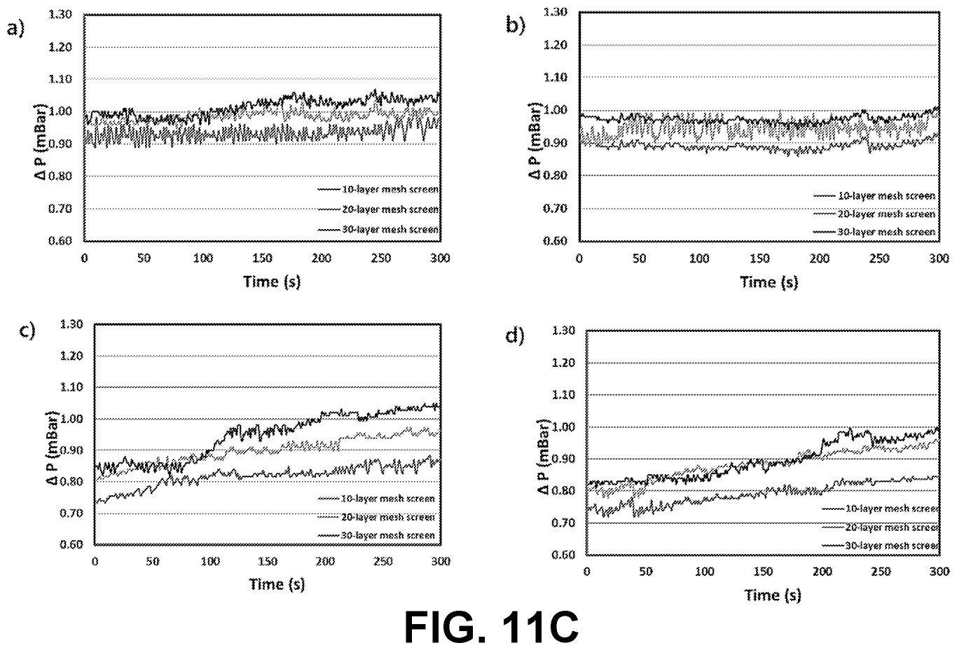

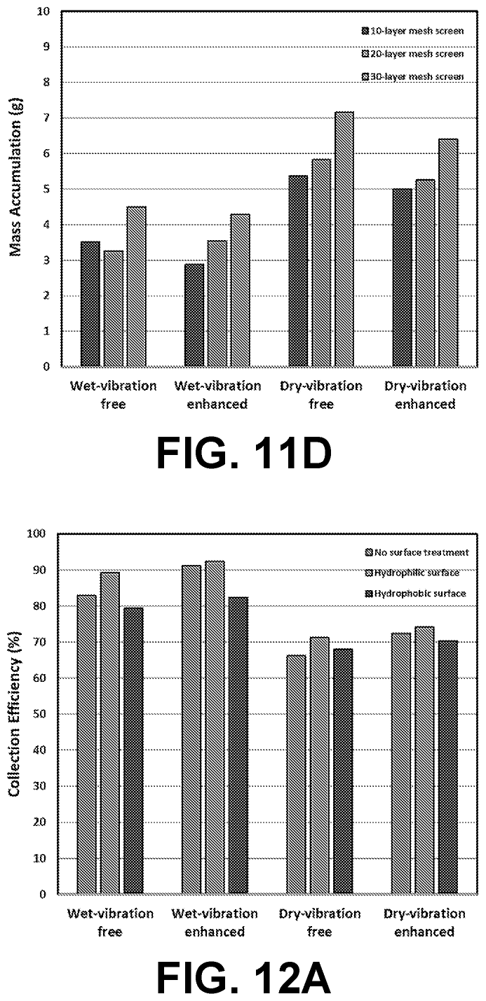

Dust collection efficiency data from these tests by different mesh screen packages with various filter layering under various operational modes is shown in FIG. 11A. The data obtained from the dust collection efficiency calculations showed that regardless of what filter package were used when the mesh screen is enhanced with the vibration, better results are obtained in both wet and dry conditions compared to the tests conducted in static condition. These differences are sometimes negligibly small for some operational conditions. However, an improvement of about 3.5% was obtained in the collection efficiency with the 30-layer screen in the wet vibration-enhanced operational condition compared to the same screen type under the wet vibration-free condition. The 30-layer wet vibration-enhanced operational condition was the most efficient run (92%). This is followed by the 30-layer wet vibration-free state with 89% efficiency. When each operational condition is evaluated in itself, it can be seen that the lowest efficiency of that operational condition is always taking place with a 10-layer screen. The maximum achieved efficiency with the 10-layer screen was under the wet vibration-enhanced operational condition (80%) and the lowest was about 77% under the dry vibration-free condition.

While collection efficiency is one evaluation metric, it must be considered alongside other metrics of performance. As such, throughout the same tests, the pre-test and post-test conditions of the downstream airflow were monitored. The difference of these two values shows how much airflow loss occurs through the test duration. The greater the detected loss in airflow implies greater mesh clogging and thus lower the overall system efficiency. Downwind section airflow loss on mesh screen with different filter layering under various operational modes from this analysis is shown in FIG. 11B. The highest airflow loss occurred in the test with a dry and vibration-free operational condition with 30-layer screen (3.5 m/s). The conditions with the least air loss were the tests with a 10-layer screen in each operational condition. The lowest airflow loss occurred when a 10-layer mesh screen was used under the wet vibration-enhanced operational condition (0.81 m/s).

As a supportive indicator to the airflow loss parameter, the pressure difference data read digitally from the downstream and upstream directions of the system continuously throughout each run. FIG. 11C illustrates examples of Δp across the mesh screen with different screen packages. Plot (a) shows the wet & vibration-free mode, plot (b) shows the wet & vibration mode, plot (c) shows the dry & vibration-free mode, and plot (d) shows the dry & vibration mode. This data shows that the pressure in the wet condition tests always starts higher than the dry condition test, likely due to the water layer that coats the mesh and reduces mesh porosity. However, when the pressure change is monitored throughout the test, the data shows that the pressure changes in the tests performed under wet conditions is much less than the increase in pressure changes under dry conditions. Because the initial pressure created by the water sprayed on the screen causes the initial pressure in the tests performed in wet conditions to start from high.

The data show that the pressure difference in dry condition reaches much higher values (avg. 20% increase) than in wet condition (avg. 3.13% increase). The pressure drop increase throughout the test explains the partial clogging of the mesh screen. In the wet condition, no significant differences were observed in the vibrating and non-vibrating conditions. In addition, in each operational condition, the minimum increase in pressure difference was obtained in the tests performed with the 10-layer filter assembly under wet vibration-enhanced operational condition (2.2% increase), and the maximum pressure difference is obtained in the tests performed with the 30-layer filter assembly (22.4% increase).

In addition to these data, in order to further support the assessment of system efficiency, after each test, the filter assembly of that test was passed through an ultrasonic bath. The mass of material obtained from this procedure is indicative of the amount of dust accumulated on the filter during the test. This parameter is one of the most important parameters showing the clogging of the filter. As shown in FIG. 11D, the operational condition in which the largest mass of particles accumulated on the filter during the test was the test with a 30-layer filter assembly under dry vibration-free condition (7.2 g). The operational condition where the least dust accumulation occurred on the mesh screen surface was the test with a vibrating 10-layer filter assembly under wet condition (2.9 g).

Although vibrating the mesh screen has been promising in many cases, it can be inferred from the combined data that there are a few situations where the static state is more advantageous. For example, while the air loss in the wet vibrating condition decreased by 7.78% compared to the vibration-free condition in the tests performed with the 30-layer mesh screen, the airflow loss in the wet test using the 20-layer vibrating filter increased by 1.87% compared to the vibration-free condition. Similarly, a decrease of 4.77% is observed in the vibrating 30-layer screen under the wet condition compared to the vibration-free condition, while an increase of 9.14% is observed in the amount of dust accumulated on the filter surface with the vibrating 20-layer mesh screen compared to the vibration-free condition. When all these data are combined, the performance of the 10-layer screen is remarkable in terms of air loss and dust accumulation on the filter. However, when the system efficiency is also considered, significant decreases are observed in the 10-layer screen compared to the higher-layer filter packages in each operational situation. The reason for its less overall efficiency is that the dust-laden air passes the 10-layer filter screen without getting captured by water droplets more easily than others. Since less dense screens cause an increase in the amount of material that can move downstream of the system, they are negatively affecting the system efficiency.

When all the test results are considered together, the data show that the lowest air velocity and pressure loss and the lowest amount of mass accumulated on the screen is the test performed under the wet vibrating operational condition performed with a 20-layer filter.

Influence of Mesh Surface Treatment. The surface of the filter panels can be coated in different ways to increase wettability and enhance particle-liquid adhesion. For example, the filters can be 316 stainless steel pads and/or woven filters (e.g., 100 & 200 mesh). The contact angle of the bare steel can be 92.6°+1.45°, which is considered hydrophobic. In order to fully observe the effects of filter surface modification, the filters can be modified to become hydrophilic and super hydrophobic. For example, the hydrophilic surface modification can be completed by reacting the iron of the steel in a low oxygen environment furnace at 750° C. to produce a blued steel oxide magnetite (Fe₃O₄). The contact angle produced from this heat treatment was about 37.1°±1°. Super hydrophobic surface modification can be completed by thinly coating the filters with a commercial polymer agent. The filter can be coated multiple times (e.g., three times) in a thinned solution and dried 24 hours before use. The contact angle measured from this modification was 156.6°±0.88°. Super hydrophobic filter coatings were obtained using a commercial polymer agent using the application instructions provided by the vender. Alternatively, the hydrophilic filters can be obtained by heating them in a high-temperature low-oxygen environment furnace at 750° C. for 20 minutes, allowing the formation of a blue magnetite layer on the surface of the stainless-steel filter.

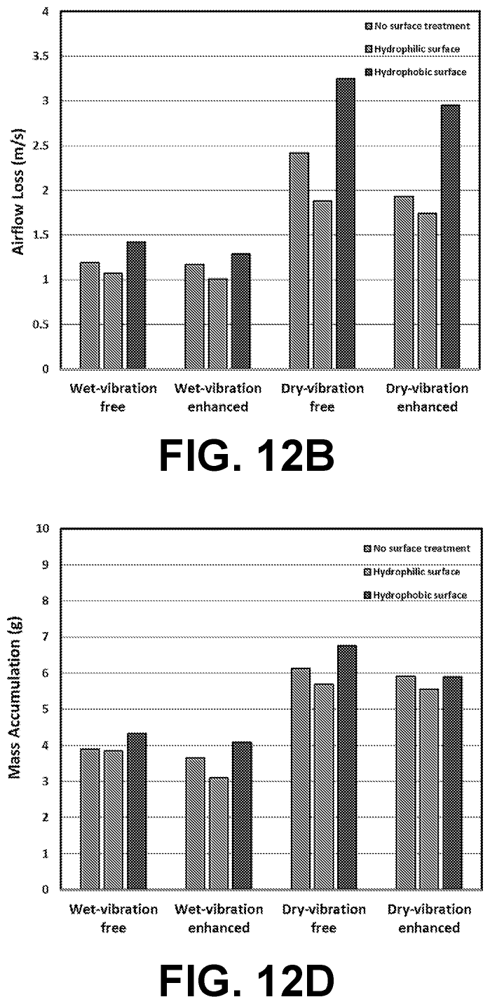

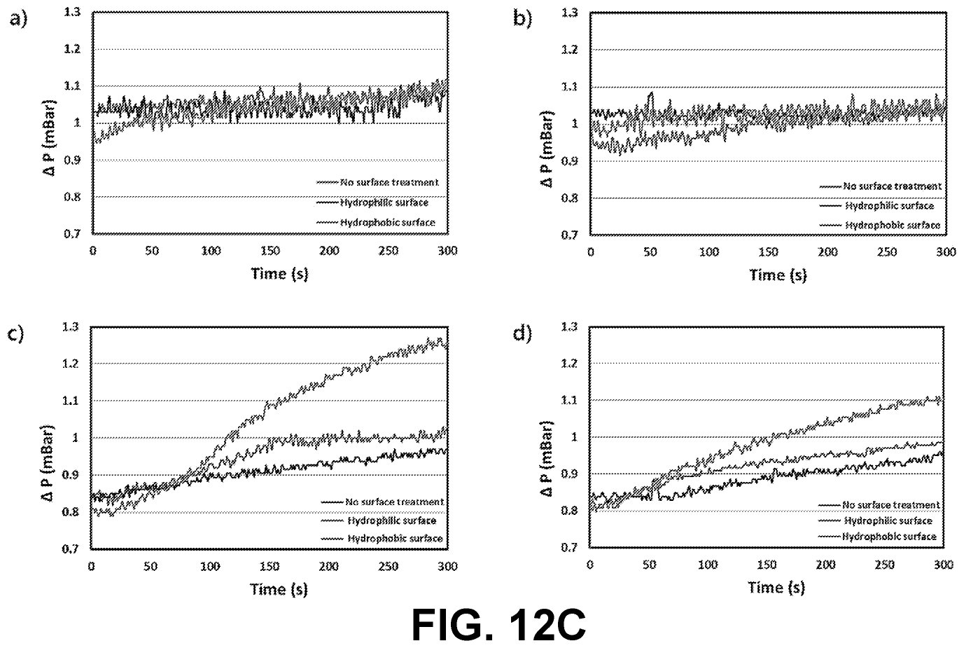

Data from these tests are shown in FIGS. 12A to 12D and include measurements of both dust collection efficiency and clogging mitigation. First, FIG. 12A shows the dust collection efficiency by different mesh screens with various surface treatments for the specified operational conditions. Across all conditions, the hydrophilic surfaces imparted the highest collection efficiency, with the differences being more pronounced for the vibration free conditions as opposed to the vibration enhanced conditions. These results compare well to the indicated advantages of a hydrophilic treated mesh.

Airflow loss data for the tested operational conditions are shown in FIG. 12B. Downwind section airflow loss on the mesh screen with different surface treatment applications under various operational modes is illustrated. As anticipated, the dry conditions showed the highest airflow loss, and in all cases, the hydrophilic mesh outperformed the other two. Overall, this data follows the same trend as that of collection efficiency with the difference between the various treatments being more pronounced in the vibration free cases.

Similarly, FIG. 12C shows the real time pressure drop data (Δp across mesh screen with different surface treatments) through the test duration. Plot (a) shows the wet & vibration-free mode, plot (b) shows the wet & vibration mode, plot (c) shows the dry & vibration-free mode, and plot (d) shows the dry & vibration mode. For the wet-condition tests, the pressure drop was similar for all three surface treatments; however, significant deviations were observed in the dry tests. Generally, the hydrophilic and bear meshes performed similarly, with the hydrophobic mesh exhibiting a significantly higher pressure drop.

Lastly, the mass of particle accumulation on the filter, which is another parameter that indicates the clogging process of the mesh screen and shows the self-cleaning capacity of the filter, was examined. The mass accumulation on the mesh screen with different surface treatments under various operational modes from this analysis is shown in FIG. 12D, and closely follows the trends of airflow loss shown in FIG. 12B.

When the tests carried out under various operational conditions with different surface modifications are examined together, hydrophobic surface modifications tended to reduce system efficiency relative to the baseline, while hydrophilic treatment tended to improve conditions. This result closely aligns with that of the laboratory testing and validates the approach employed. In explaining the findings, when water contacts hydrophilic surfaces, it forms a film, whereas when it contacts hydrophobic surfaces, it beads up. Since water droplets are highly mobile, if the surface becomes hydrophobic, the area covered by water droplets is significantly reduced of the total mesh wire surface area. Besides, hydrophilic coating is increasing the amount of liquid surface area on mesh, which increases chances of dust particles getting captured by the water droplets.

### Prototype Testing

Design and Construction. A robust system was designed to demonstrate the capabilities of vibratory mesh assemblies in full-scale, including the vibration translation system. The preliminary design process ensured the attainability of adequate airflow, waste-water egress, and mesh excitation. In addition, the unit was designed to be tested at the NIOSH dust gallery where testing of similar dust scrubber technologies is ongoing.

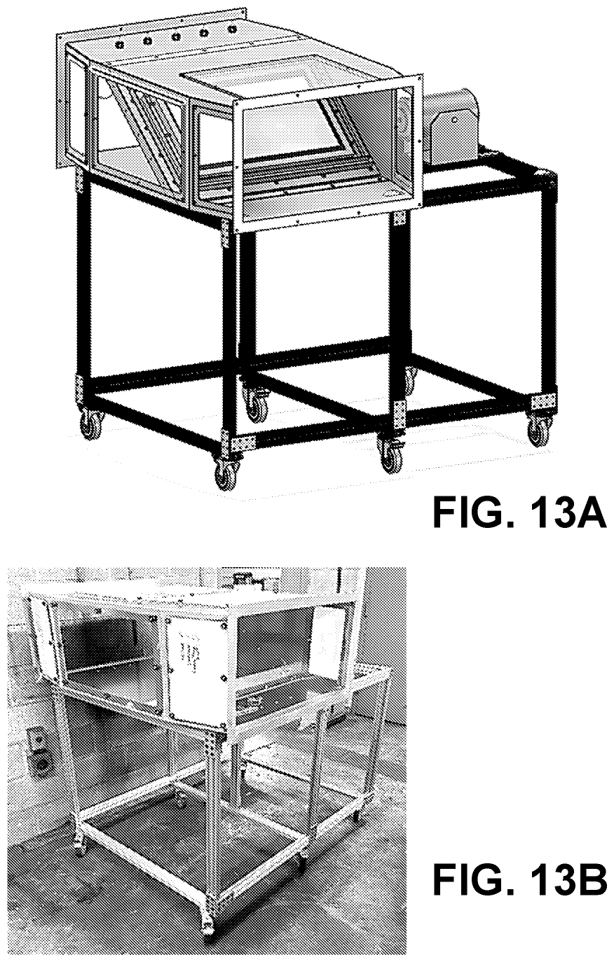

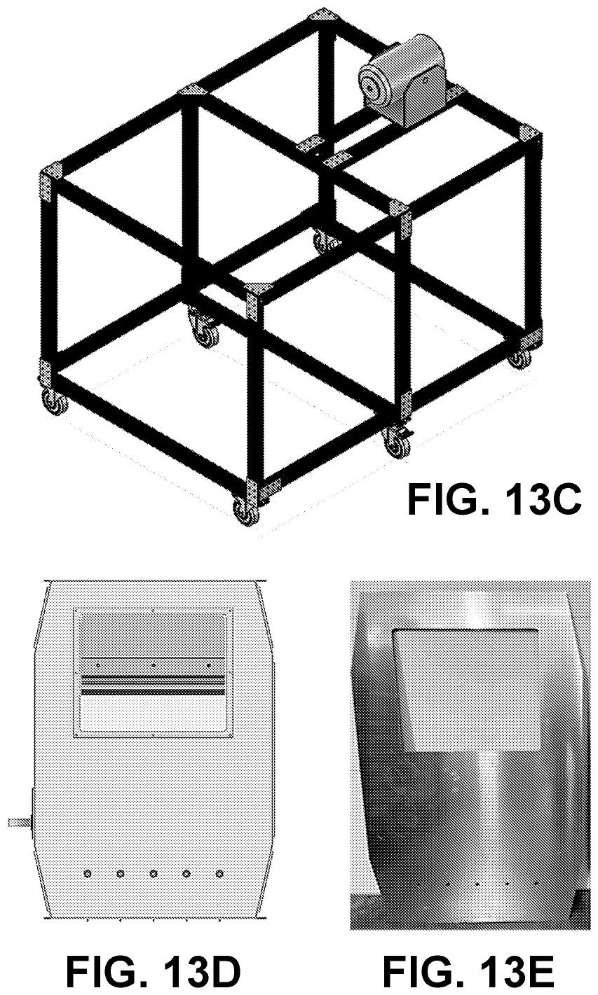

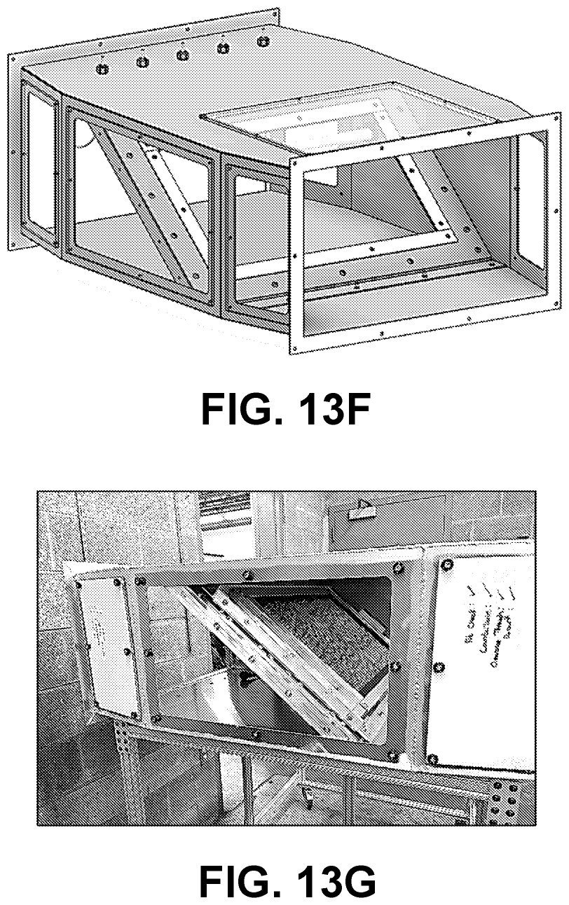

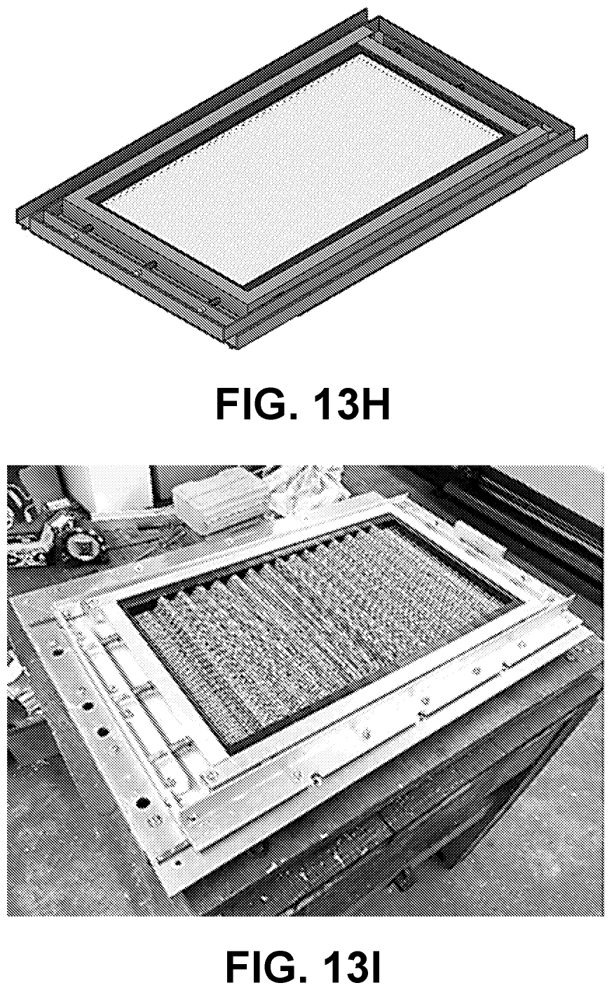

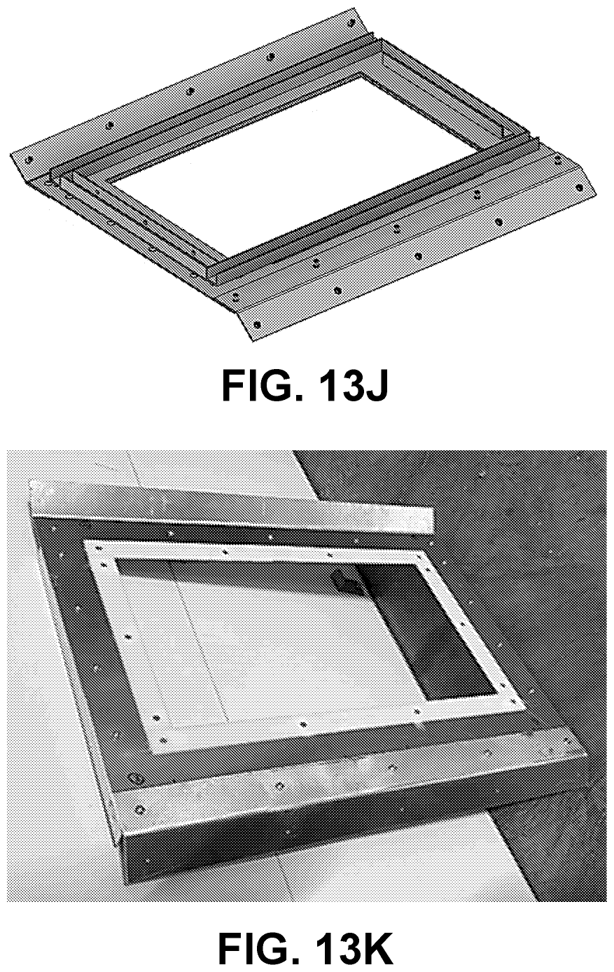

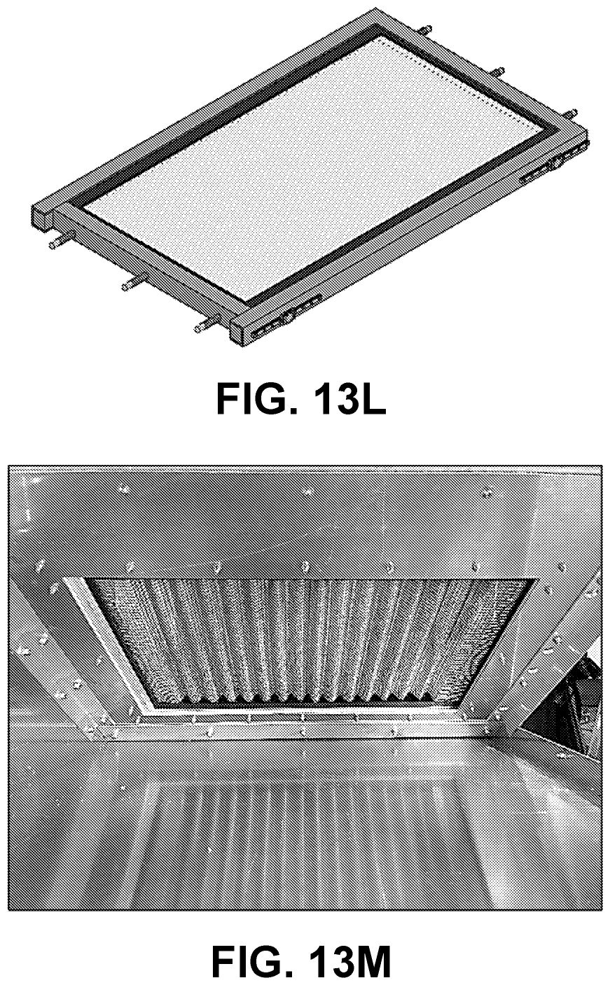

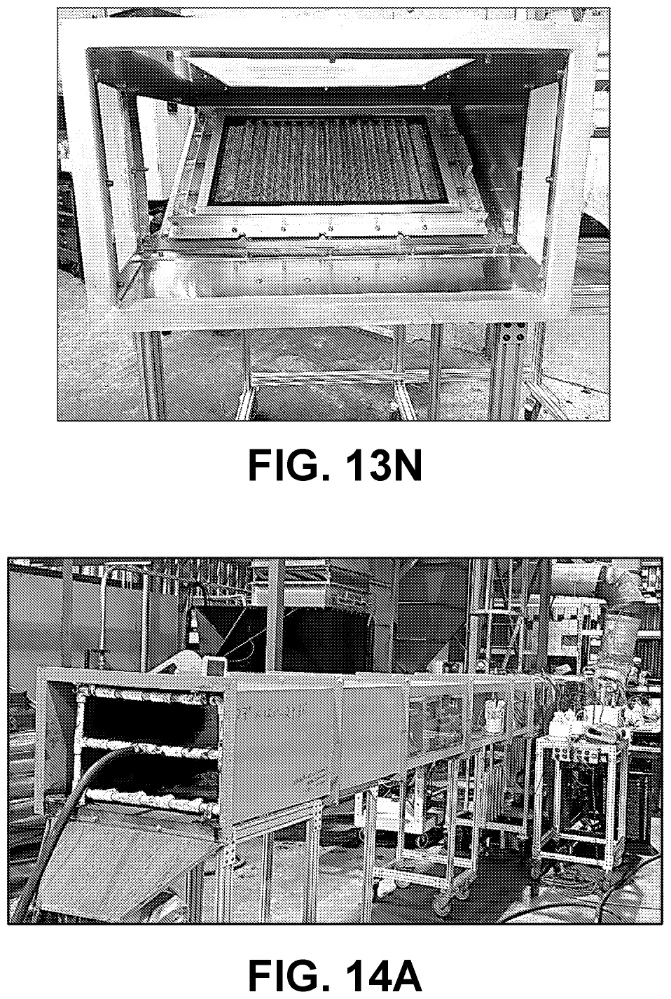

FIG. 13A is a schematic diagram illustrating the full-scale vibratory prototype comprising a stand and shaker assembly, exterior tunnel structure, and interior vibratory mesh assembly; all of which adopted the modular structure found at the NIOSH facility. The fabricated full-scale unit is shown in the image of FIG. 13B. This prototype design and construction focused on the novel mesh section of the scrubber. Use of an existing particulate feeding system, water management system, demister assembly, and exhaust puller fan, analogous in nature to equipment found on a traditional flooded bed scrubber, has been provided by NIOSH for testing. The unit has been designed and manufactured as a direct replacement of NIOSH's static-mesh scrubber section, eliminating the need for any on-site modification to their scrubber unit.

Stand and Shaker Assembly. The stand assembly houses the scrubber mesh section and shaker and was constructed identical in nature to those found at the NIOSH facility. It was fabricated using an 8020-aluminum structure and bracketry. As shown in FIG. 13C, the shaker is securely mounted to the stand offset to the tunnel mounting location. The shaker utilized for this iteration of the project is a Modal Shop 2110E. This shaker can provide 110 lbf pk of sine force, a frequency range up to 6500 Hz, and a stroke distance of 1.0 inches; these specifications make this shaker an ideal option as it meets the operational parameters needed for testing.

Tunnel Structure. FIG. 13D is a top view schematically illustrating the tunnel structure for the system. The exterior structure of the unit was developed to modularly adapt to NIOSH's existing flooded bed dust scrubber for testing purposes. The system at NIOSH comprises individual chamber sections with interior dimensions of 15.50×27.00 inches and employs a static mesh with the dimensions of 15.75×25.25 inches. Inability to package the vibratory mesh assembly within the confines of the NIOSH scrubber dimensions prompted a tapered chamber design. This taper, shown in FIG. 13D, opens the interior of the chamber to a width of 32.25 inches, a total increase in width of 5.25 inches or a 2.625-inch increase in width from the chamber centerline.

This outward taper can decrease the velocity of air through this section of the chamber, but only marginally. As static and dynamic testing will be performed with the same mesh and chamber section in place, the potential effects of this change in geometry on airspeed will be negated through baseline control testing.

The structure itself is composed of eight individually plasma cut flat panels assembled and fabricated into a single structure using exterior fillet-welded corner joints. The image of FIG. 13E shows the plasma cut chamber top panel with the taper. The material chosen for chamber construction was 0.125-inch 5052-H32 aluminum sheet. The assembly was fabricated using the Gas Tungsten Arc Welding (GTAW) process with 4042 filler material. While the NIOSH unit is constructed of carbon steel, aluminum was selected for this unit to minimize the mass of the finished assembly. A 5052 series aluminum was chosen, in lieu of a 6000 series alloy, for its cracking resistance when formed and bent, superior corrosion resistance, and weldability.

The chamber structure contains six separate viewing windows for later testing use and data collection. Visual monitoring, implementing a high-speed camera, can be applied to trace and characterize particulates flowing through the mesh. These windows were constructed out of 0.25-inch-thick polycarbonate and were located on all four of the tapered panels, the mesh egress panel, and the top panel of the chamber. The mesh egress window can be used for both viewing purposes, upstream and downstream of the mesh, and for the installation of the vibratory mesh assembly into the unit.

FIG. 13F schematically illustrates the chamber with air block plate. This hollow structure is substantially reinforced using thick edge-flanges and an interior air-block plate. The edge flanges, shown in FIG. 13F, are equal in exterior dimension to the NIOSH unit and both designs share an identical hole pattern for ease of installation. They are constructed of 1.50-inch height×0.125-inch thickness 90° aluminum angle. The addition of the air-block plate and its accompanying panel mounts triangulate the interior of the structure and mechanically fasten the walls, ceiling, and floor of the chamber. The image of FIG. 13G shows the fabricated chamber with air block plate installed. This plate also provides chamber sealing for around the mesh and acts as a solid mounting surface for the vibratory mesh assembly. The plate is mounted within the structure on a layback angle (e.g., a 50° layback angle or in a range from about 45° to about 55°, or about 40° to about 60°), similar to the setup found in small-scale testing.

Vibratory Mesh Assembly. FIG. 13H schematically illustrates the vibratory mesh assembly (VMA) and FIG. 13I includes an image of the fabricated VMA. While preliminary small-scale testing utilized a directly driven mesh, the full-scale prototype system focuses on harvesting and transferring machine-generated vibrations to the mesh. This transference of vibration is noteworthy due to the ease of installation of this novel system onto existing mining equipment without the need for modifications. The implementation of machine-driven transference can be applied through the vibratory mesh assembly. This assembly, shown in FIGS. 13H and 13I comprises two separate sub-structures constrained using linear roller bearings.

The driven panel, shown schematically in FIG. 13J attached to the air block plate and seen in the image of FIG. 13K, acts as the base of the vibratory mesh assembly of which all components are fastened. This panel attaches directly to the air-block plate through the use of four separate linear bearing carriages and rails and acts as the mounting interface between the chamber and shaker. These bearings allow for lateral movement of the assembly within the chamber with a maximum stroke of 1.00 inch. Another set of bearings and carriages are affixed to the upward portion of the driven panel for mounting of the mesh assembly.

FIG. 13L schematically illustrates an example of the mesh panel assembly comprising a filter mesh in a mounting frame with damping springs providing the elastic foundation or base. The mounting frame surrounds the mesh and is mechanically fastened to the driven panel through the secondary set of linear bearings. This dual-bearing design allows for independent range of motion from the chamber to the driven panel and from the driven panel to the mesh panel. A set of compression springs, mounted to the driven panel, act as hard mounts from the driven panel to the mesh panel. This set of springs maintains the range of motion of the assembly, within the stroke range of the driven panel, using the coil-bind of the spring as a hard-stop. Additionally, the springs will indirectly translate lateral driven movement, from the driven panel to the mesh panel, simulating machine harvested vibration. The fabricated mesh panel assembly is shown in FIG. 13M.

The completed interior assembly, including the air-block plate and vibratory mesh assembly, provides adequate sealing with minimal bypass of coal-laden upstream air. FIG. 13M shows the upstream section of the completed assembly. The design provides airflow over the full surface area of the mesh through the entire stroke of the shaker. As the assembly contains two positions of linear motion, low friction sealing surfaces were needed to mitigate strain on the shaker. A slippery polyethylene, UHMW, was chosen for the sealing surfaces and was designed and installed between both linear assemblies.

Lastly, FIG. 13N shows the opposing, downstream, side of the interior assembly. The vibratory mesh assembly and air-block plate are shown installed into the chamber body. This figure clearly displays the viewing windows surrounding the mesh that will aid in visual data collection during the testing phase at the NIOSH facility.

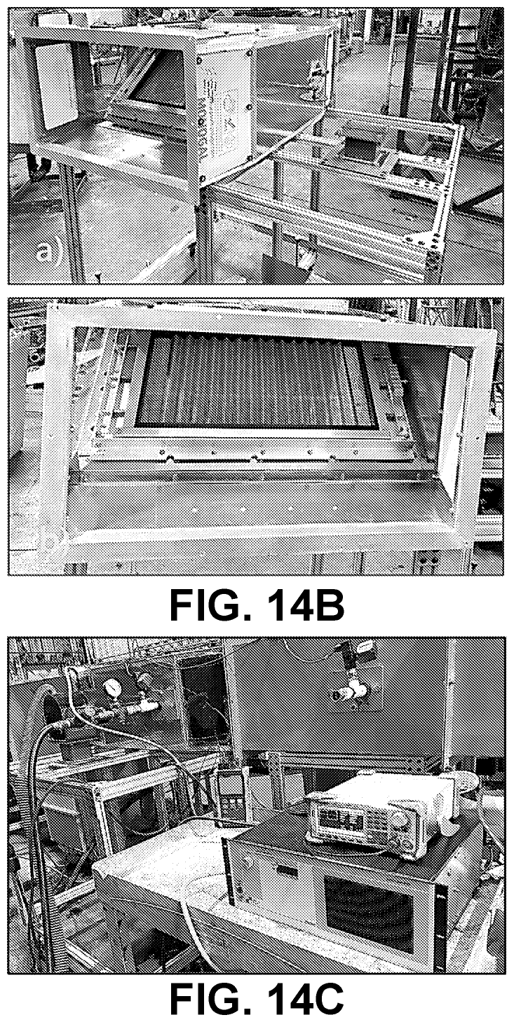

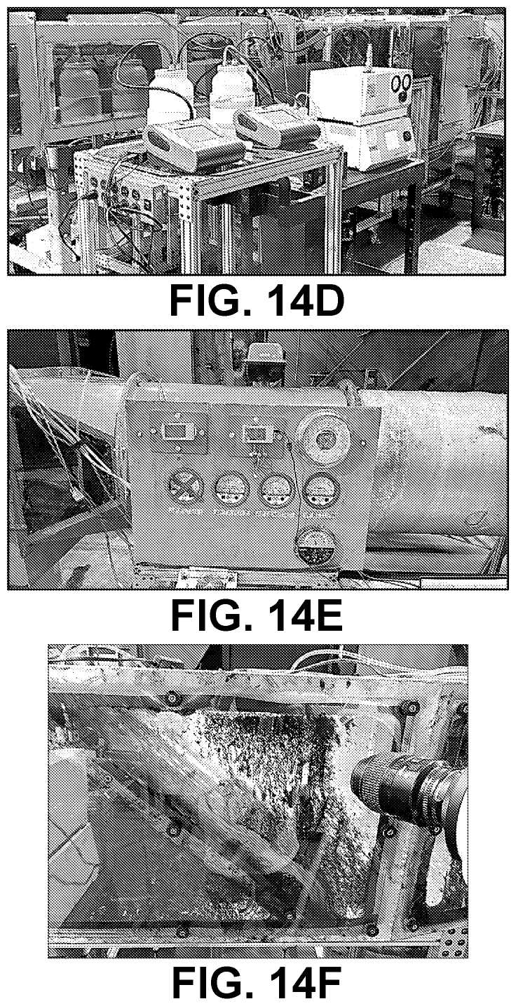

Materials and Methods. Test setup and Procedures. Testing of the prototype system was conducted at the NIOSH Dust Gallery using the systems and infrastructure in place. The experimental investigation studied the influence of various operating parameters (e.g., vibrational frequency, amplitude, mesh housing design, and mesh design) on dust capture and self-cleaning potential. The primary experimental trials were conducted with the standard fine coal dust blend that is used in the NIOSH dust gallery. The apparatus for testing included the standalone dust scrubber configuration, that includes several tunnel sections as well as a discharge fan, demister, water management system, and residual dust collection system. FIG. 14A includes an image of the standalone dust scrubber unit. A single custom-built tunnel section was supplied that comprises the vibrating mesh configuration shown in the images of FIG. 14B (mesh housing section—top—and vibrating mesh configuration—bottom) and a vibratory unit in the image of FIG. 14C. The vibratory kit includes a dual-purpose platform shaker with power amplifier and a cooling package. The electrodynamic exciter is capable of imparting 489 N (110 lbf) pk sine force and 25.4 mm (1″) pk-pk stroke.

The existing system was pretested to determine the operational and cleaning procedure for the filter and duct. Subsequent tests followed standard protocols and procedures for the dust scrubber system that have been developed by NIOSH. During each test, the fan, water sprays, mesh shaker, and dust feeding system (sequentially in that order) were initiated. Gravimetric sampling measurements were utilized using sample collection cassettes & vacuum pumps through the duration of the test. The image of FIG. 14D shows the upstream sampling configuration of the testing. Pressure drops across mesh screen and demister and air velocity were measured using pressure gauge and pitot tube before introducing dust as well as throughout the duration of the test. FIG. 14E is an image of the pressure monitoring station. The spent filters were cleaned using garden hose, the water sump was emptied when needed, and the system was prepared for a new run between tests (pre-test pressure drop was utilized as an indicator of cleanliness).

Similar to the bench-scale trials, the first block of experiments was designed using response surface methodology to empirically quantify the correlation between several independent variables and a response variable. To develop response surfaces, a 3-factor Box-Behnken-Design (BBD) was employed, and the experimental data was statistically analyzed. Surface plots were generated after data analysis. As dictated by the experimental program, 15 runs were conducted. 12 of the runs were performed using different combinations of the independent variables, and 3 repeated runs were performed at the test center point. Table 11 shows the factors associated with the independent variables. The experimental program was developed using Minitab software in order to set up a reliable regression model with the least amount of error at the end of the experiment. Analyzing the experimental results from 12 different combinations of the three independent variables and 3 repeated trials with only mid-level factors illustrates the significance of the operational factors in determining mesh screen dust collection performance.

TABLE 11
Experimental factors and range values for full-scale scrubber test.

Level

| Factors | Low (−1) | Medium (0) | High (+1) |
|---|---|---|---|
| Spring rate (lbs/in) | 10 | 103 | — (solid) |
| Amplifier gain (Vpp) | 1 | 2 | 3 |
| Frequency (Hz) | 10 | 70 | 130 |

The constant parameters in the experimental setup are defined in table 12. The duration of the test, dust feed rate/concentration in the duct, water flow rate, water spray nozzle pressure and the initial airflow rate were mainly determined by the capability of the facility's equipment capability. Test duration was determined as 25 minutes when the gravimetric sampling is employed to allow sampling cassettes to collect sufficient amount of dust concentration to evaluate the system efficiency.

TABLE 12
Fixed operating parameters for full-scale scrubber test.

| Property | Unit | Values |
|---|---|---|
| Dust feed rate | g/min | 250 |
| Nozzle pressure | PSI | 37 |
| Dust composition | — | Grounded fine coal dust |
| Test duration (for gravimetric | Min | 25 |
| sampling) | | |
| Fan speed | Hz | 60 |
| Mesh layering | — | 30-layer |

After the initial experimental program, three additional runs were conducted using the mid-values of the vibrational parameters, and different mesh screens with various layering, and three more runs were conducted with the same mesh screen layering configurations but with no vibration. The six additional tests were performed to compare vibrating and non-vibrating conditions under different mesh screen layering as shown in table 13. These tests were performed using the same fixed operating parameters as shown in table 12.

TABLE 13
Post experimental program testing.

| | Vibration | Mesh |
|---|---|---|
| Run | conditions | layering |
| 1 | Vibration-free | 10-layer |
| 2 | Vibrating mesh | 10-layer |
| 3 | Vibration-free | 20-layer |
| 4 | Vibrating mesh | 20-layer |
| 5 | Vibration-free | 30-layer |
| 6 | Vibrating mesh | 30-layer |

High Speed Video Analysis. During the latter stage of the testing campaign, highspeed video analysis was conducted in conjunction with the performance evaluation. The purpose of this effort was to characterize the particle-laden fluid flows in a mesh. One high-speed camera (Photron Nova S6), one LED light, as well as the attendant auxiliary equipment were utilized in the study. As shown in the image of FIG. 14F, the camera was installed next to the wet scrubber with an added clear plastic window that allowed for observation through it. Additionally, having a clear top window enabled an LED light to be placed above it to illuminate the mesh better during the experiments.

The high-speed camera was placed close enough by the side window to capture coal-laden water droplets coming off the mesh quickly and accurately without any obstruction or difficulty thanks to the two windows. This setup gave full control over the observations while also providing detailed images of particles flying off the meshes which would be impossible otherwise without the need for precise placement of tools like cameras, lights, etc.

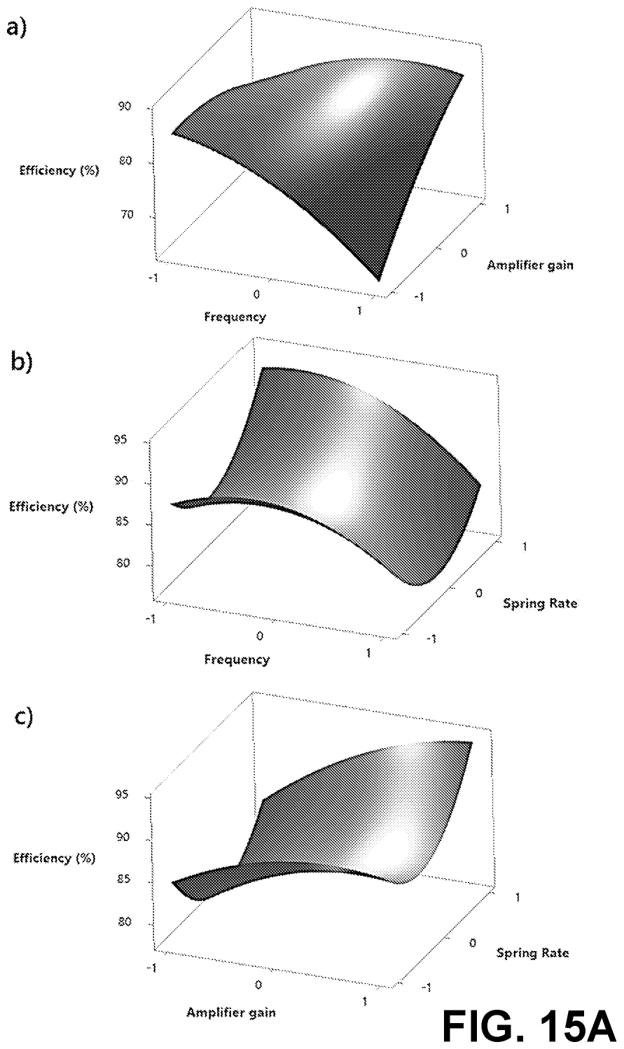

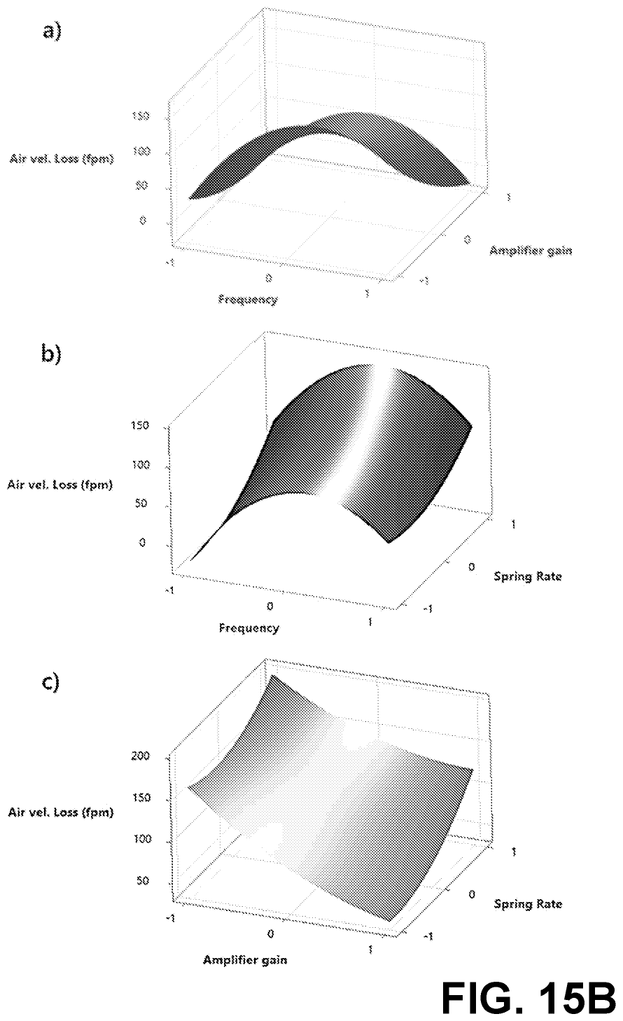

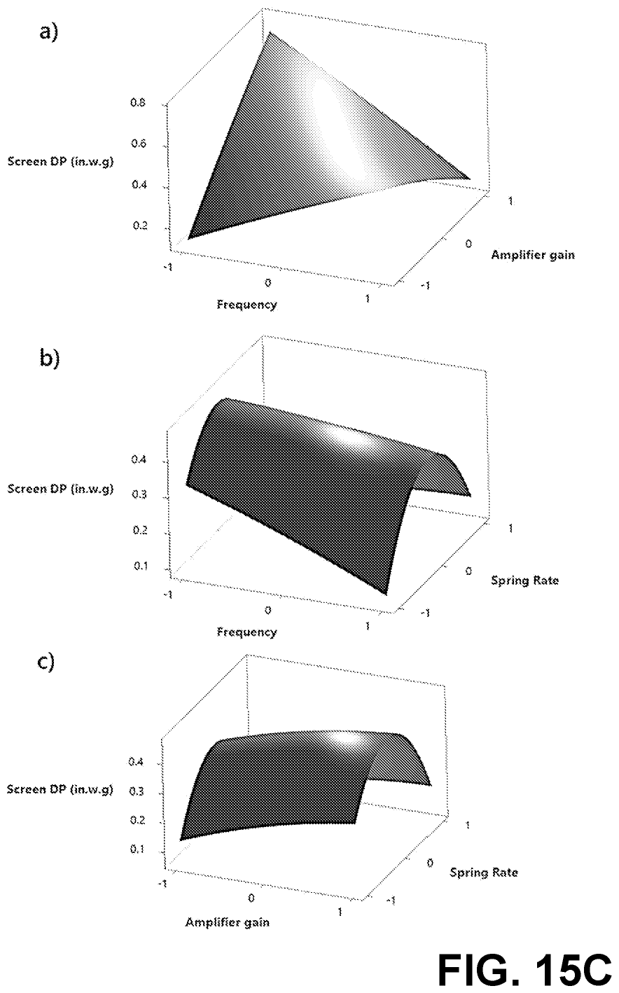

Vibrational Parameter Optimization Results. The tests carried out in the dust gallery of the NIOSH facility consist of two primary campaigns. In the first part, the experimental design was applied and 15 tests were carried out with different variations of the previously determined variables shown above. Throughout the test, data was collected via gravimetric sampling, real time dust concentration monitoring with DustTrak, real time optical particle size analysis with APS, analog air velocity monitoring, analog pressure drop across the screen and demister, and analog velocity pressure monitoring of the downstream air. Response surface plots were created with the obtained results and are shown in FIG. 15A through FIG. 15C. Each figure shows the effect of two different variables on response by keeping one of the three variables used during the experiment constant.

FIG. 15A shows surface plots of collection efficiency (%) vs (a) amplifier gain and frequency, (b) spring rate and frequency, and (c) spring rate and amplifier gain The collection efficiency surface was plotted from the data obtained with the gravimetric sampling. Dust concentration data were obtained in real time with DustTrak and APS; however, they were not used in the analysis due to their inconsistency and calibration issues that were noted during testing. In plot (a) of FIG. 15A, the effect of the interaction of the amplifier gain with the frequency on the efficiency is examined. The highest efficiencies (over 85%) were obtained when the frequency values were at medium and above, and at the same time the amplifier gain values were at the highest. The effect of the interaction of the spring constant with the frequency on the efficiency shown examined in plot (b) of FIG. 15A. The highest efficiency values (over 92%) were obtained when the spring constant is at the highest and the frequency is close to the medium value. However, it is worth noting that the collection efficiencies approaching 90% under the conditions where the spring constant is at its lowest and the frequency is close to the medium values. As observed in plot (a) and plot (c) of FIG. 15A, the spring constant does not impart a significant difference in efficiency, especially under low amplifier gain conditions. In addition, higher efficiency was always achieved under test conditions with the highest application gain.

When taken together, the highest efficiency values were obtained when the frequency is at its medium value (70 Hz), the amplifier gain is at the highest (3 Vpp), and the spring constant is also at the highest (solid spacer). It should be noted, though that the effect of the spring constant used on the prototype screen will not exhibit the same behavior as the spring constant to be used in the real mine unit. The spring constant may need to be reoptimized in an operational prototype, and it is likely that a lower spring constant value will produce the desired results. The laboratory tests have shown that this lower spring constant configuration can move the screen independently and consistently from the outer frame.

FIG. 15B shows surface plots of upstream airflow loss (fpm) vs (a) amplifier gain and frequency, (b) spring rate and frequency, and (c) spring rate and amplifier gain In FIG. 15B, the effects of the binary interactions of the variables used in the test on the air velocity lost during the test were examined. In plot (a) of FIG. 15B, where the effect of amplifier gain and frequency pair on air velocity loss is examined, it can be seen that the air velocity loss is most pronounced when the amplifier gain value is at its least (1 Vpp) and the frequency values are close to the medium values (70 Hz). As shown in plot (b) of FIG. 15B, the air velocity loss reaches its highest (over 140 fpm) values where the spring constant is at its highest and the frequency is at its medium values. Lastly, it can be seen in plot (c) of FIG. 15B that the amplifier gain is inversely proportional to the spring constant, but in an almost exact linear relationship. Accordingly, it was observed that the air velocity loss is the most significant (over 175 fpm) when the amplifier gain is at its least and the spring constant is at its highest. When taken together, the data show that the air velocity loss can be optimized when the amplifier gain values are at the highest, the spring constant value is at the lowest and the frequency is between medium and highest values. In addition to all these, when the air velocity pressure data in the downstream was examined, no significant change was found in any condition. Air velocity pressure drop at downstream close to fan were generally negligible throughout the test.

Lastly, FIG. 15C shows surface plots of pressure drop across the mesh screen (in.w.g) vs (a) amplifier gain and frequency, (b) spring rate and frequency, and (c) spring rate and amplifier gain. FIG. 15C shows the effect of the binary interactions of the variables used in the experimental design on the pressure drops across the screen. As shown in plot (a) of FIG. 15C, the interaction of frequency and amplifier gain does not have any significant effect on the increase in pressure drops across the screen. For example, in cases where there is high frequency and high amplifier gain, the lowest screen pressure drop is observed, whereas the lowest pressure drop values are also obtained at the lowest frequency value and the lowest amplifier gain. Therefore, it can be said that these two do not have a consistent effect on the related response. In addition, as shown in plot (b) of FIG. 15C, the most significant increases in the pressure drop across the screen (over 0.4 in.w.g) are observed in cases where the frequency value is between its medium and low and the spring constant is close to its medium value. Similarly, plot (c) of FIG. 15C shows that when the amplifier gain value is between its medium and high and the spring constant is close to its medium value, the most significant increases in pressure drop across the screen are observed (over 0.4 in.w.g).

In addition, when the pressure drop data across the demister is examined, the data show that there is almost no increase in pressure drop in most conditions. There are even increases in the total pressure difference due to the location where the demister outlet is closest to the fan. The data show that the variables used in the experiment design do not have any significant effect on the pressure differences across the demister.

When taken together, the data indicate that the pressure drop is optimized when the spring constant is at its medium, the frequency value is between the medium and low range, and the amplifier gain is between its medium and high range.

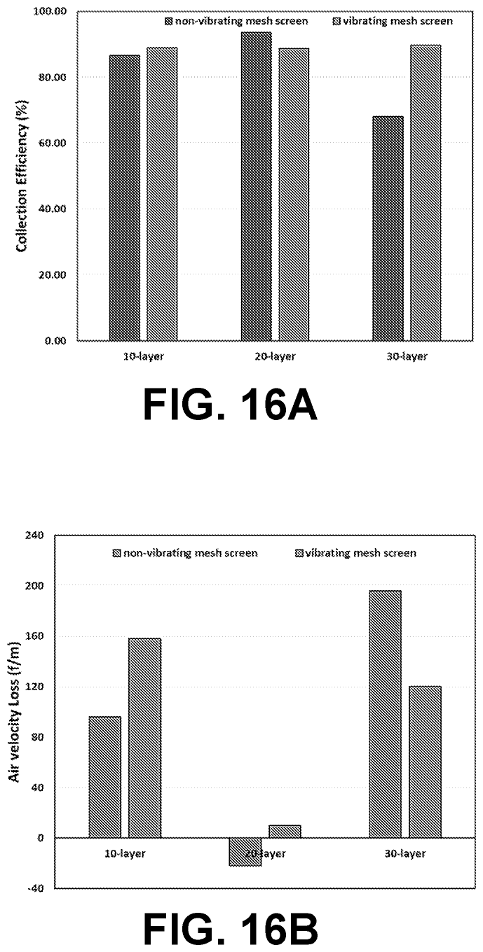

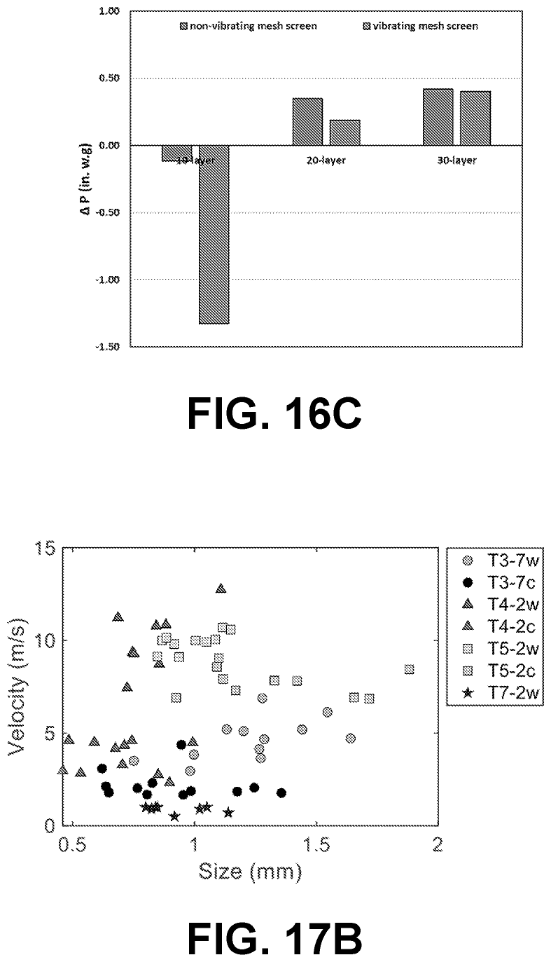

Influence of Mesh Density and Vibration. The second part of the tests carried out at the NIOSH facility with the full-size prototype consists of six tests with mesh screens with different steel mesh layers. These tests include vibrating and non-vibrating conditions of those mesh screen variations. The response parameters examined are the same with those examined in the earlier tests including the collection efficiency, the change in the air velocity at the system inlet during the test, and the pressure drops on the screen during the test. FIG. 16A shows collection efficiency by different mesh screen packages with various filter layering under vibrating and non-vibrating operational modes. FIG. 16B shows upstream section airflow loss by different mesh screen packages with various filter layering under vibrating and non-vibrating operational modes. FIG. 16C shows pressure drops across the mesh screen by different mesh screen packages with various filter layering under vibrating and non-vibrating operational modes.

As shown in FIG. 16A, collection efficiency in the vibrating condition decreased only in the test with the 20-layer screen, however, the collection efficiency increased in the tests with the 10-layer and 30-layer screens. The effect of the difference between vibrating and non-vibrating conditions on the collection efficiency was most evident in the test with a 30-layer filter (32% increase). The collection efficiency was highest (94%) when tested with a 20-layer screen in vibration-free conditions. In addition, the test with the lowest efficiency was the test performed with a 30-layer screen in vibration-free conditions (68%). Comparing the 3 different screen types, although the highest efficiency was obtained in the vibration-free test with the 20-layer screen, it is worth noting that vibration increased the dust collection efficiency of the system in both tests using 10-layer (from 87% to 89%) and 30-layer (from 68% to 90%) screens.

In FIG. 16B, the initial and final air velocity changes of the tests carried out in vibrating and non-vibrating conditions with screens with different steel mesh layer densities are given. Accordingly, in the 10-layer and 30-layer tests, significant air velocity losses were observed in the system (over 100 fpm), while no significant air velocity loss was observed in the tests performed with the 20-layer screen. It should be noted that the air velocity loss was greater in the tests with the vibrating 10-layer screen, and much greater in the tests with the non-vibrating 30-layer screen. These results are inconsistent and further testing and analysis of the measurement system may be needed to discern the implications of the findings.

FIG. 16C shows the difference in the pressure drop detected across the screen during the tests performed. In tests with the 10-layer screen, the pressure drop decreases both in vibrating and non-vibrating conditions. It is considered that this may be due to the high air velocity upstream of the 10-layer screen. On the other hand, in the tests performed with 20- and 30-layer screens pressure drop increased throughout the tests. Less pressure drop increases were detected in the tests performed under vibrating conditions with both screen types. This finding supports the presence of vibration increasing the self-cleaning capacity of the screen compared to the vibration-free state.

When the findings of the first and second parts of the experiments with the full-size prototype are combined, it can be said that the vibration-enhanced systems using 20 or less dense layered screens will positively affect the overall efficiency of the flooded bed dust scrubber. However, the tests performed in the NIOSH facility with the 10-layer mesh screen showed that regardless of vibrating condition there could be some waterflow passing the demister and going through the fan. This could damage the fan and affect the correct data generating process. In order to eliminate this issue in the tests with 10-layer screen, either water flow rate or airflow rate can be decreased. If the air and water flow rates are wanted to be kept at their current values, the design of the demister can be modified as a more sophisticated solution.

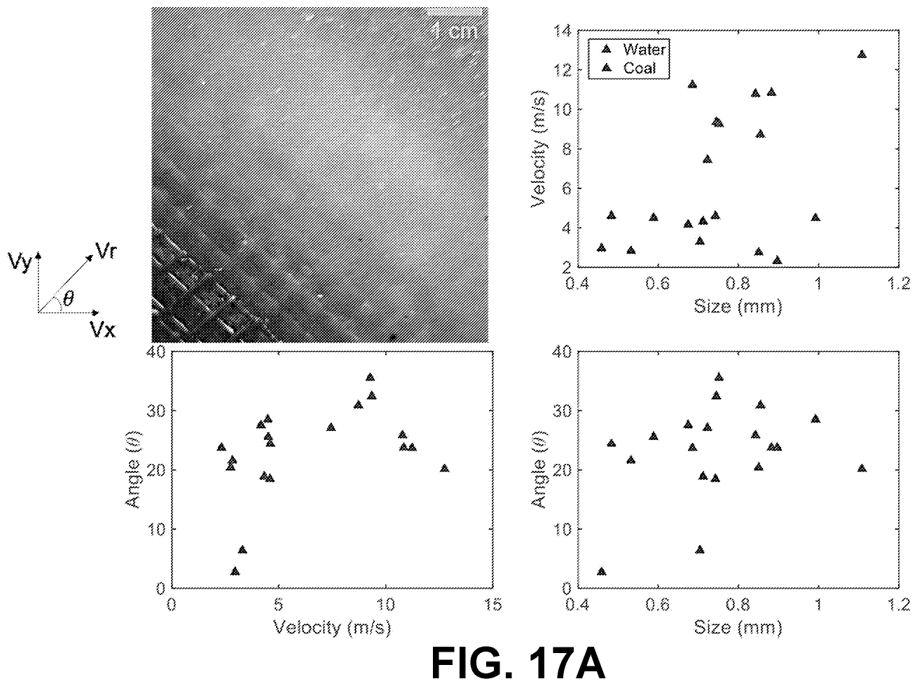

Highspeed Video Analysis. FIG. 17A shows the analysis of the highspeed video collected from one of the tests. In the experiment, we were able to observe both clean water droplets and coal-laden droplets were observed coming off from the mesh. The left-top panel is an image of the wet scrubber showing a snapshot of the droplets. The right-top graph illustrates velocity versus size of droplets, with water droplets and coal-laden particles. The bottom two graphs illustrate ejection angle versus velocity (left) and ejection angle versus size (right). The frequency of coal-laden droplets was less than that of pure water ones. Additionally, the velocity of coal-laden droplets was slower than that of pure water due to their increased specific density caused by the presence of coal particles in them. As a result, this led to a lower angle trajectory for these heavier drops as they fell down under gravity more compared with clean water ones.

The size distribution of coal-laden droplets from the wet scrubber was observed to be slightly smaller than the water droplets. This phenomenon is explained by the concept of surface tension, which determines how much energy it takes for liquids to form into spherical shapes before they are expelled as droplets. In presence of coal particles in fluids, the surface tension gets lower and hence results in shorter capillary length and subsequently smaller ejected drop sizes. The lower surface tension does not have a significant impact on size distribution here since we saw slight decrease in drop sizes compared with pure water ones, which can also be explained by the surface tension change.

FIG. 17B shows the data collected from a series of experiments conducted to measure the speed of coal-laden droplets and water droplets. The legend represents different video names, with the last letter indicating whether it is a coal-laden (“c”) or water droplet (“w”). As expected, the data showed that coal-laden particles had lower speeds than pure water particles under similar conditions; this explains why so many dense concentrations of coal were observed just after passing through the wet scrubber. The results suggest that having a drainage system directly after leaving the wet scrubber would be beneficial in collecting all these heavy particles before they can cause any damage to other parts of duct system downstream. This could help protect against corrosion and clogging due to large amounts of particulate matter being released into other areas where it may not be desired or safe for them to accumulate too heavily over time.

The results of the laboratory and prototype testing confirmed that the vibrating mesh system can improve operational outcomes over that of a static mesh system, and fundamental modeling efforts have provided insight into particle clogging within porous mesh materials. The final test prototype integrated several design features derived from the fundamental testing, notably including the use of a hydrophilic mesh and the use of a flexible housing to translate external vibration. Based on the work of this project, the vibrating mesh technology has matured to TRL 6, prototype validated in a relevant environment. The demonstrated system can be developed as a fully integrated system in an operational mine worthy system for use on to a continuous miner. A mine worthy unit would facilitate broader commercialization within the industry.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A filter system for removing dust particles from underground mining, the filter system comprising:
(a) a mesh system comprising one or more meshes secured by a frame;
(b) a frame bed for holding the mesh system, wherein the frame bed receives vibrational energy from a continuous miner; and
(c) a means for transferring vibrational energy from the continuous miner to the mesh system, wherein the means for transferring the vibrational energy are positioned between and in contact with the frame bed and the mesh system.

2. The filter system of claim 1, wherein the mesh system comprises two or more meshes adjacent to and in contact with one another.

3. (canceled)

4. (canceled)

5. The filter system of claim 1, wherein each mesh is a 100-mesh to 325-mesh.

6. (canceled)

7. The filter system of claim 1, wherein the one or more meshes comprises 1 to 30 layers of woven steel.

8. The filter system of claim 1, wherein the mesh system has a thickness of from about 1 mm to about 10 mm.

9. The filter system of claim 1, wherein the mesh comprises a plurality of wires, wherein the wires have a diameter of from about 0.05 mm to about 0.20 mm.

10. The filter system of claim 1, wherein the mesh system is heated at a temperature of from about 700° C. to about 800° C. from about 5 minutes to about 60 minutes.

11. The filter system of claim 1, wherein each mesh comprises a coating.

12. The filter system of claim 11, wherein the coating is hydrophilic or a nonionic surfactant comprising alkylene oxide units.

13. (canceled)

14. The filter system of claim 11, wherein the coating comprises an inorganic material comprising hydroxyl groups exposed on the surface.

15. The filter system of claim 11, wherein the coating comprises an inorganic material comprising one or more metal oxides.

16. (canceled)

17. (canceled)

18. The filter system of claim 1, wherein the means for transferring vibrational energy comprises one or more springs.

19. The filter system of claim 18, wherein the spring has a spring constant that provides a natural frequency greater than the range of frequencies produced by the continuous miner.

20. The filter system of claim 18, wherein the spring has a spring constant from about 5×10⁵ N/m to about 2×10⁷ N/m.

21. The filter system of claim 1, wherein the means for transferring vibrational energy comprises an elastic material.

22. A method for removing dust particles from underground mining produced by a continuous miner, the method comprising contacting the dust particles with the filter system in claim 1, wherein the filter system is mounted to the continuous miner, and wherein the continuous miner produces vibrational energy sufficient to vibrate the mesh system in the filter system.

23. The method of claim 22, wherein the filter system is configured between the inlet and outlet of a scrubber system, which is attached to the body of the continuous miner.

24. The method of claim 22 or 23, wherein the continuous miner produces vibrational energy having a frequency of less than 1,000 Hz, or from about 100 Hz to 1000 Hz.

25. The method of claim 22, wherein the dust particles are contacted with water prior to contacting the filter system.

26. The method of claim 22, wherein the method further comprises removing the filter system from the continuous miner, cleaning the mesh system of the filter system to remove all or substantially of the dust particles from the one or more meshes, and re-installing the filter system on the continuous miner.
